(19) United States
(12) Patent Application Publication
(10) Pub. No.: US 2004/0086323 A1
(43) Pub. Date: May 6, 2004

(54) Binder

(75) Inventors: Kanji Tanaka, Osaka-shi (JP); Hiroshi Arai, Osaka-shi (JP); Hiroshi Nakano, Osaka-shi (JP)

Correspondence Address: Joseph R. Keating, Esq., Keating & Bennett LLP, Suite 312, 10400 Eaton Place, Fairfax, VA, 22030, US

(73) Assignee: LIHIT LAB., INC., Osaka-shi (JP)

(21) Appl. No.: 10/694,540

(22) Filed: Oct. 27, 2003

(30) Foreign Application Priority Data
Oct. 25, 2002 (JP) 2002-311772
May 29, 2003 (JP) 2003-152410
Jul. 2, 2003 (JP) 2003-190647

(51) Int. Cl. B42F 13/00

(52) U.S. Cl. 402/73

(57) ABSTRACT

A binder that can be opened/closed relatively easily by manually handling the tops of binding rings includes a holding member having a sufficient length to allow binding rings to be arranged with a spacing therebetween, and an operating member fixed movably to the inner side of the holding member such that the binding rings anchored to the surface thereof are fixed to the holding member. The operating member includes a pair of operating pieces movable along the longitudinal direction of the holding member within the holding member, and a pivot shaft formed along the abutting edges of the pair of operating pieces. Further, an opening/closing member is provided to move the operating pieces within the holding member in the longitudinal direction of the holding member while rotating the pair operating pieces around the pivot shaft in the directions to open the binding rings.

### BACKGROUND OF THE INVENTION

1. Field of the Invention

The present invention relates to a binder and a manufacturing method thereof, and more particularly, the present invention relates to a binder for use, for example, as a ring binder or file and a manufacturing method thereof.

2. Description of the Prior Art

Ring binders are known as a type of binders. These ring binders include a binding ring having a substantially annular shape constituted by a pair of semicircular elements, the opposing ends of which are engaged with each other to close the ring at the center thereof. The ring is opened manually by a user, using fingers to pull the pair of semicircular elements in opposite directions such that the opposing ends thereof are spaced apart from each other.

However, it may be difficult for a user to open this substantially annular binding ring, gripping the pair of semicircular elements with fingers, especially when a relatively large number of papers or other articles are filed in the binding ring.

In order to solve this problem, a ring file has been proposed by Japanese Patent Laid-Open Publication No. Hei 10-337988.

This prior art ring file has a binder of a standing-lever type that is designed such that substantially annular binding rings are opened by pressing down the inner side of a standing lever. Such configuration, however, imposes a problem in that, when a large number of articles are bound in the binding rings, the bound article becomes an obstacle which makes it difficult to press the standing lever with fingers from the bound article side to the outside.

### SUMMARY OF THE INVENTION

In order to overcome the problems described above, preferred embodiments of the present invention provide a binder that can be opened and closed relatively easily by manually handling the tops of binding rings of the binder and a method of manufacturing such a novel binder.

According to a first preferred embodiment of the present invention, a binder includes binding rings, a holding member having a sufficient length to allow the binding rings to be arranged with spacing therebetween, and an operating member on a surface of which the binding rings are anchored at bases thereof with spacing therebetween, and which is movably fixed to an inner side of the holding member such that the binding rings are fixed to the holding member. The cylindrical slide portions are preferably arranged along the abutting edge of one of the operating pieces at appropriate intervals and cylindrical slide portions are arranged along the abutting edge of the other operating piece so as to be loosely fitted between the cylindrical slide portions, a pivot shaft being passed through the cylindrical slide portions.

The opening/closing member is preferably provided in a gap located between the cylindrical slide portions of the operating pieces.

The gap is preferably provided between the cylindrical slide portions of the operating pieces so that the opening/closing member is provided in the gap. Also, an inner end of the cylindrical slide portion of one of the operating pieces preferably faces the gap, and, in opposition to the inner end, an inner end of the cylindrical slide portion of the other operating piece faces the gap.

A first pivot shaft piece is preferably arranged at the abutting edge of one of the operating pieces, a second pivot shaft piece is arranged at the abutting edge of the other operating piece so as to be overlapped with the first pivot shaft piece, and a pivot shaft is passed between the first and second pivot shaft pieces.

A gap is preferably provided at the abutting edges of the operating pieces so that the opening/closing member is provided in this gap, a gap-side inner end of one of the operating pieces faces the gap, and, in opposition to this gap-side inner end, a gap-side inner end of the other operating piece faces the gap.

The opening/closing member preferably includes an elastic member which is provided between a pair of operating pieces constituting the operating member for moving the pair of operating pieces in the opposite directions, respectively, and for elastically urging the pair of operating pieces in the directions so as to hold the binding rings in the opened or closed state.

The elastic member preferably includes a coil spring which is wound around the pivot shaft of the operating member, and arranged in contact with the cylindrical slide portion of one of the operating pieces of the operating member and with the cylindrical slide portion of the other operating piece such that one end of the coil spring presses one of the operating pieces of the operating member, and the other end pressing the other operating piece.

In another preferred embodiment, the elastic member preferably includes a coil spring which is wound around the pivot shaft portion and is arranged in contact with a gap-side inner end of one of the operating pieces and with a gap-side inner end of the other operating piece such that one end of the coil spring presses one of the operating pieces of the operating member, and the other end pressing the other operating piece.

The holding member is preferably provided with a movement restricting portion on an inner surface of a holding wall inside of which the operating member is disposed. A latch of the opening/closing member extending towards the holding wall of the holding member is engaged with and held by a latching portion of the operating piece, while abutting against the movement restricting portion of the holding member, for restricting the movement in the holding member of the operating member disposed inside the holding member and of the opening/closing member for activating the operating member.

According to yet another preferred embodiment of the present invention, a method for manufacturing a binder which includes binding rings, a holding member having a sufficient length to allow the binding rings to be arranged with spacing therebetween, and an operating member on a surface of which the binding rings are anchored at bases thereof with spacing therebetween, and which is movably fixed to an inner side of the holding member such that the binding rings are fixed to the holding member, the method including the steps of juxtaposing inside the holding member a pair of operating pieces constituting the operating member, one of the bases of each binding ring being fixed to one of the operating pieces and the other of the bases being fixed to the other operating piece, such that these operating pieces are capable of moving in a longitudinal direction of the holding member within the holding member, inserting a pivot shaft through a pivot shaft portion disposed at abutting edges of the pair of operating pieces from a pivot shaft insertion hole formed on a longitudinal central line of the holding member, and fixing an opening/closing member to the pivot shaft portion, such that the opening/closing member moves the operating pieces within the holding member in the longitudinal direction of the holding member, while rotating the pair of operating pieces around the pivot shaft portion to directions to open the binding rings.

The step of juxtaposing the operating pieces preferably includes a step of juxtaposing a pair of operating pieces having a pivot shaft piece constituting the pivot shaft portion disposed at the respective abutting edges such that the pivot shaft pieces of the pair of operating pieces are overlapped with each other. Also, the step of inserting the pivot shaft preferably includes a step of inserting the pivot shaft between the pivot shaft pieces.

According to preferred embodiments of the present invention, an opening/closing member is provided which, when opening binding rings, moves operating pieces within a holding member in the longitudinal direction of the holding member and simultaneously causes the pair of operating pieces to pivot around the pivot shaft portion of an operating member to change their directions to open the binding rings. Therefore, when the binding rings are twisted by fingers, the operating pieces are moved within the holding member by the opening/closing member to enable the binding rings to be opened. Thus, the binding rings can be opened and closed very easily.

Cylindrical slide portions are preferably disposed along the abutting edge of one of the operating pieces at appropriate intervals and cylindrical slide portions are disposed along the abutting edge of the other operating piece so as to be loosely fitted between the aforementioned cylindrical slide portions, and the operating pieces are rotated around a pivot shaft passed through the slide portions. Accordingly, the binding rings can be opened and closed securely and easily.

The opening/closing member is preferably provided in a gap formed between the cylindrical slide portions of the operating pieces. Therefore, the opening/closing member occupies a small volume and the opening/closing member as well as the operating member can be accommodated within the holding member in a compact fashion.

A gap is preferably formed between the cylindrical slide portions of the operating pieces so that the opening/closing member is disposed in this gap. Therefore, the opening/closing member can be accommodated in the gap in a compact fashion.

Pivot shaft pieces are preferably constructed by folding the operating pieces and a pivot shaft is passed between these pivot shaft pieces. Therefore, the pivot shaft pieces thus formed allow the pivot shaft to be passed relatively stably and accurately.

A gap is preferably formed at the abutting edges of the operating pieces so that the opening/closing member is provided in this gap. Therefore, the opening/closing member can be accommodated in the gap in a compact fashion.

The opening/closing member preferably includes an elastic member which is provided between a pair of operating pieces constituting an operating member for moving the pair of operating pieces in the opposite directions, respectively, and also for elastically urging the pair of operating pieces in the directions to hold the binding rings in the opened or closed state. Therefore, the pair of operating pieces constituting the operating member can be moved and at the same time the binding rings can be held in the opened or closed state by the elastic member constituting the opening/closing member.

In another preferred embodiment, the elastic member preferably includes a coil spring which is wound around the pivot shaft of the operating member, and arranged in contact with the cylindrical slide portion of one of the operating pieces of the operating member and with the cylindrical slide portion of the other operating piece such that one end of the coil spring presses one of the operating pieces of the operating member, and the other end pressing the other operating piece. Therefore, the elastic member moves the pair of operating pieces so that the binding rings attached to the operating member can be opened and closed smoothly.

The elastic member preferably includes a coil spring which is wound around the pivot shaft portion and arranged in contact with the gap-side inner end of one of the operating pieces and with the gap-side inner end of the other operating piece such that one end of the coil spring presses one of the operating pieces of the operating member, and the other end pressing the other operating piece. Therefore, the elastic member moves the pair of operating pieces so that the binding rings attached to the operating member can be opened and closed smoothly.

The holding member is preferably provided with a movement restricting portion on the inner surface of a holding wall inside of which an operating member is disposed, a latch of the opening/closing member extending towards the holding wall of the holding member is engaged with and held by a latching portion of the operating piece, while abutting against the movement restricting portion of the holding member, for restricting the movement in the holding member of the operating member disposed inside the holding member and of the opening/closing member for operating the operating member. Accordingly, the movement of the operating member and pivot shaft in the longitudinal direction of the holding member is restricted, and therefore, if the operating member and holding member are made from metal, no noise will be made by the movement of these members.

A pivot shaft portion can be formed relatively easily by inserting the pivot shaft portion from a pivot shaft insertion hole in the holding member and passing through the operating member and an opening/closing member. Therefore, a binder can be manufactured in an efficient manner.

A pivot shaft piece for pivotably supporting the pivot shaft can be disposed at the abutting edge of the operating piece relatively accurately, for example by folding the pivot shaft piece formed in continuation with the operating piece made from a metallic plate. Therefore, such pivot shaft pieces can be aligned on a straight line, and the pivot shaft can be passed straightly and smoothly between the pivot shaft pieces.

These and other features, elements, characteristics and advantages of the present invention will become more apparent from the detailed description to follow with reference to the attached drawings.

### BRIEF DESCRIPTION OF THE DRAWINGS

FIG. 1 is a perspective view showing an example of a binder according to a preferred embodiment of the present invention;

FIG. 2 is a plan view of the binder in the closed state;

FIG. 3 is a bottom view of the binder in the closed state;

FIG. 4 is cross-sectional view of the binder in the closed state;

FIG. 5 is a side view of the binder in the closed state;

FIG. 6 is a cross-sectional view of the binder in the opened state;

FIG. 7 is a plan view illustrating binding ring and an operating member in the closed state;

FIG. 8 is a plan view illustrating the vicinity of the latching portion of the binding ring in the closed state;

FIG. 9 is a plan view illustrating the vicinity of the end of each of the binding ring halves in the opened state;

FIG. 10 is a front view illustrating an opening/closing member;

FIG. 11 is a side view illustrating the opening/closing member;

FIG. 12 is a right side view illustrating a second operating piece;

FIG. 13 is a plan view illustrating the second operating piece;

FIG. 14 is a front view illustrating the second operating piece;

FIG. 15 is a left side view illustrating the second operating piece;

FIG. 16 is a bottom view illustrating the second operating piece;

FIG. 17 is a plan view illustrating a first operating piece;

FIG. 18 is a front view illustrating the first operating piece;

FIG. 19 is an illustration showing a method of engaging the first and second operating pieces mutually;

FIG. 20 is a plan view illustrating a binder according to an alternative preferred embodiment of the present invention in the closed state;

FIG. 21 is a bottom view illustrating the binder according to the alternative preferred embodiment of the present invention in the closed state;

FIG. 22 is a side view illustrating the binder according to the alternative preferred embodiment of the present invention in the closed state;

FIGS. 23A and 23B illustrate constitution of an operating member, FIG. 23A being a plan view of a second operating piece and FIG. 23B being a plan view of a first operating piece;

FIGS. 24A and 24B illustrate constitution of an alternative operating member, FIG. 24A being a bottom view of a first operating piece and FIG. 24B being a bottom view of a second operating piece;

FIGS. 25A and 25B illustrate an opening/closing member, FIG. 25A being a plan view thereof and FIG. 25B being a side view thereof;

FIG. 26 is a perspective view showing a binder according to a further preferred embodiment of the present invention;

FIG. 27 is a plan view of the binder in the closed state;

FIG. 28 is a bottom view of the binder in the closed state;

FIG. 29 is a cross-sectional view of the binder in the closed state;

FIG. 30 is a side view of the binder in the closed state;

FIG. 31 is a cross-sectional view of the binder in the opened state;

FIG. 32 is a plan view illustrating binding rings and an operating member in the closed state;

FIG. 33 is a plan view illustrating the vicinity of a latching portion of the binding ring in the closed state;

FIG. 34 is a plan view illustrating the vicinity of the end of each of the binding ring halves in the opened state;

FIG. 35 is a front view showing an opening/closing member;

FIG. 36 is a side view of the opening/closing member;

FIG. 37 is a left side view showing a second operating piece;

FIGS. 38A and 38B illustrate binding rings and an operating member, FIG. 38A being a plan view showing a second operating piece and other elements, and FIG. 38B being a plan view showing a first operating piece and other elements;

FIGS. 39A and 39B illustrate the binding ring and the operating member, FIG. 39A being a front view showing the second operating piece and other elements, and FIG. 39B being a front view showing the first operating piece and other elements;

FIGS. 40A and 40B illustrate the binding rings and the operating member, FIG. 40A being a right side view showing the second operating piece and other elements, and FIG. 40B being a left side view showing the first operating piece and other elements;

FIGS. 41A and 41B illustrate the binding rings and the operating member, FIG. 41A being a bottom view showing the first operating piece, and FIG. 41B being a bottom view showing the second operating piece;

FIG. 42 is a cross-sectional view taken along the line B-B of FIG. 38 showing the second operating piece;

FIG. 43 is a cross-sectional view taken along the line C-C of FIG. 38 showing the second operating piece;

FIG. 44 illustrates a method of assembling the binder;

FIG. 45 illustrates a method of assembling the binder;

FIG. 46 is a front view illustrating a stopper;

FIG. 47 is a bottom view of a binder according to a further preferred embodiment of the present invention in the closed state;

FIG. 48 is a perspective view illustrating a principal portion of the binder in the closed state;

FIG. 49 is a perspective view illustrating a principal portion of the binder in the closed state;

FIG. 50 is a bottom view of a holding member;

FIG. 51 is a right side view of the holding member;

FIG. 52 is a cross-sectional view taken along the line E-E of FIG. 50;

FIG. 53 is a left side view of the holding member;

FIG. 54 is a cross-sectional view taken along the line F-F of FIG. 51;

FIG. 55 is a cross-sectional view taken along the line G-G of FIG. 52;

FIG. 56 is a front view illustrating an opening/closing member; and

FIG. 57 is a side view illustrating the opening/closing member.

### DETAILED DESCRIPTION OF PREFERRED EMBODIMENTS

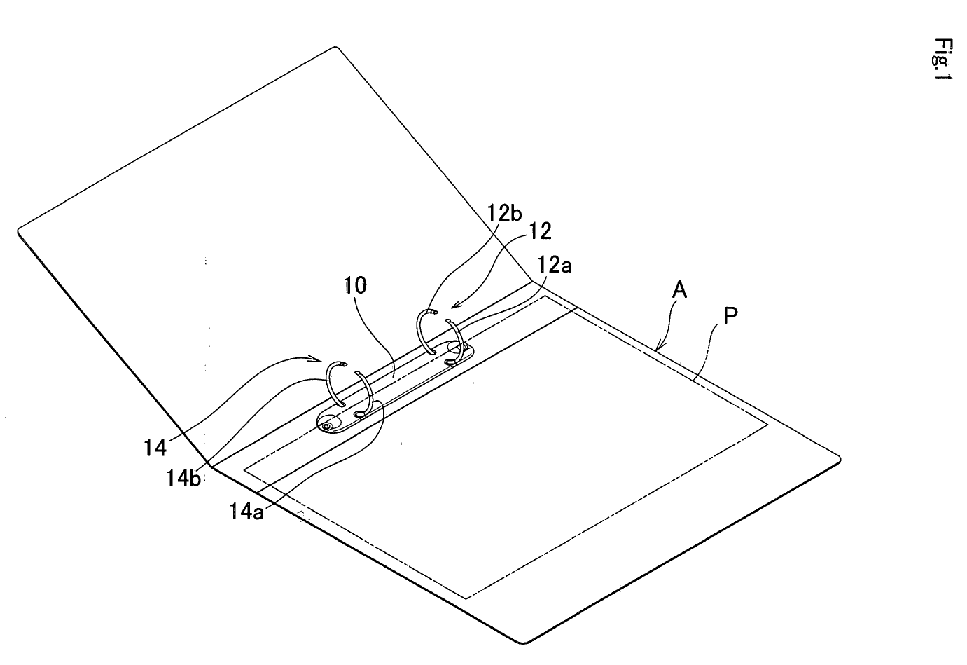

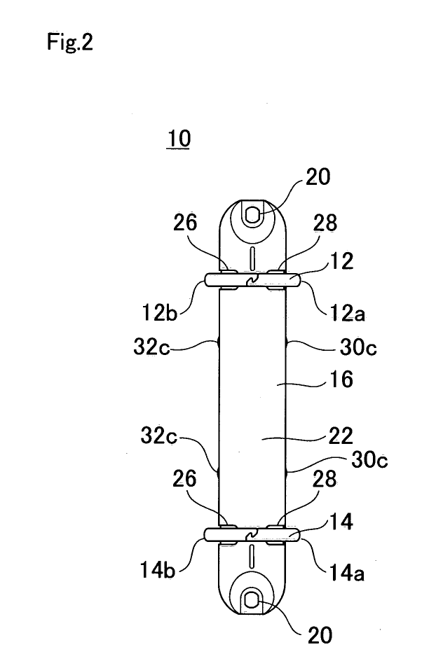

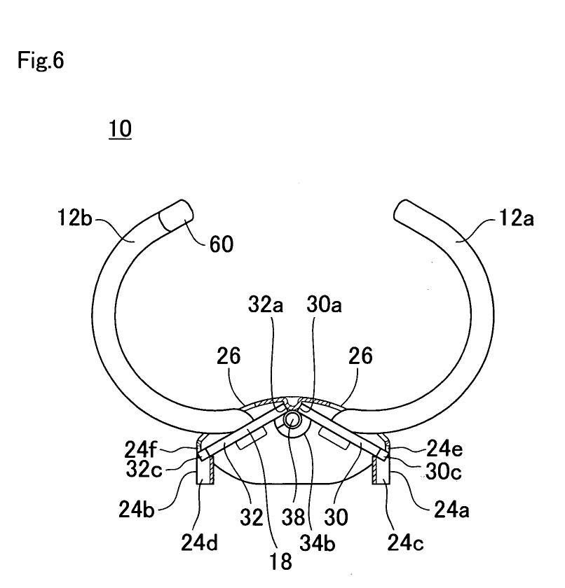

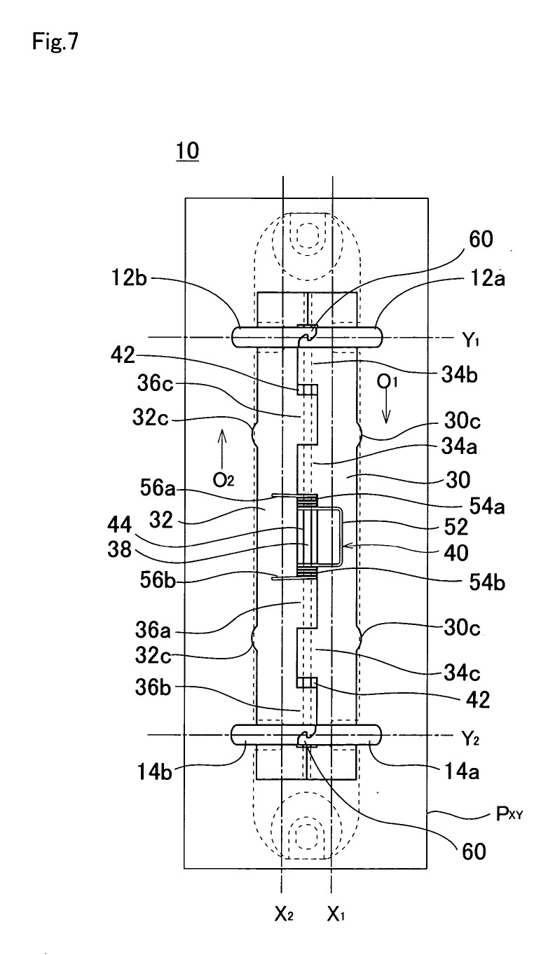

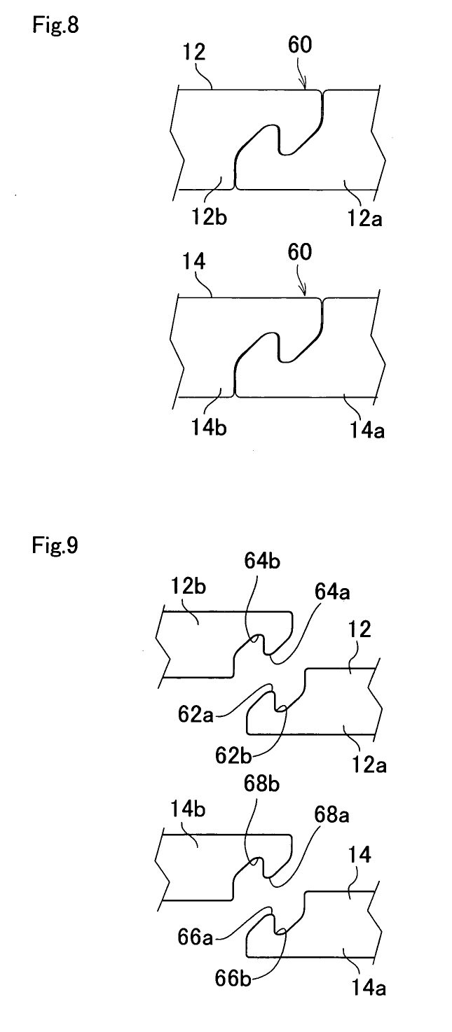

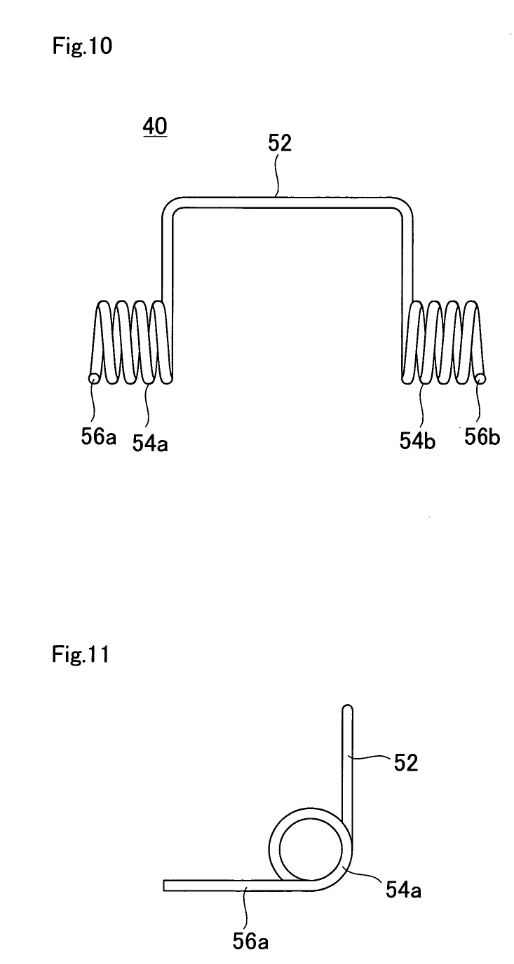

FIG. 1 is a perspective view showing an example of a binder according to a preferred embodiment of the present invention. FIGS. 2, 3, 4, and 5 are a plan view, a bottom view, a cross-sectional view, and a side view of the binder in the closed state, respectively. FIG. 6 is a cross-sectional view of the binder in the opened state. FIG. 7 is a plan view illustrating binding rings and an operating member in the closed state. FIG. 8 is a plan view illustrating the vicinity of the latching portion of the binding ring in the closed state. FIG. 9 is a plan view illustrating the vicinity of the tip end of each of the binding ring halves.

A binder 10 is fixed to the inner surface of a back cover between a pair of left and right fold lines formed substantially at the center of a cover A which is preferably made of a relatively rigid sheet material such as card board or other suitable material. The binder 10 may be fixed integrally with the back cover by inserting fasteners such as bolts and nuts or eyelets through attaching holes 20 (to be described later) formed at the opposite ends in the longitudinal direction of the binder 10.

It should be noted that, although description is made herein using bolts and nuts as the fasteners, the fasteners are not restricted thereto but other means such as screws, eyelets, or rivets also may be used. Further, it is also possible to adopt a supersonic welding or high-frequency welding technique to fasten the binder.

The binder 10 preferably includes a pair of first and second binding rings 12 and 14 preferably made of a metal and having a substantially annular shape, a holding member 16 having a sufficient length to allow the first and second binding rings 12 and 14 to be arranged with an appropriate interval therebetween, and an operating member 18 which is attached movably to the inside of the holding member 16 such that bases of the first and second binding rings 12 and 14 are anchored to the surface thereof and spaced at a distance from each other. Thus, the first and second binding rings 12 and 14 are fixed to the holding member 16.

The holding member 16 is preferably substantially rectangular as seen in the plan view, having a sufficient length to allow the first and second binding rings 12 and 14 to be arranged with an appropriate interval therebetween, and preferably has a substantially semi-circular shape in the plan view at the opposite ends, in other words, at the parts around attaching holes 20 for attaching the holding member 16 to the cover A.

The holding member 16 has a bound article mounting portion 22 which extends transversely from outside the positions where the first and second binding rings 12 and 14 are fixed and bulges out at the center to have a substantially semi-circular cross section. The holding member 16 also has a space inside the bound article mounting portion 22 so as to accommodate the operating member 18 and so on.

The bound article mounting portion 22 of the holding member 16 is provided with holding walls for holding the operating member 18 movably, such that the holding walls extend longitudinally along the edges substantially from one end to the other end of the bound article mounting portion 22. In this preferred embodiment, a holding wall 24a and a holding wall 24b are arranged longitudinally substantially over the whole length of the holding member 16 inwardly from outside the first binding ring 12 and from outside the second binding ring 14, and so as to extend downwards. Further, holding projections 24c and holding projections 24d are provided on the holding wall 24a and holding wall 24b, respectively, with an appropriate distance from each other, such that these projections project inwards from the lower edges of the holding walls 24a and 24b. These holding projections 24c and 24d are for holding a first operating piece 30 and a second operating piece 32 at the vicinities of the respective outer edges 30b and 32b.

Further, a holding hole 24e and holding hole 24f are formed respectively at the upper portion of the holding projection 24c of the holding wall 24a and at the upper portion of the holding projection 24d of the holding wall 24b, so that a holding projection 30c disposed on the outer edge 30b of the first operating piece 30 and a holding projection 32c disposed on the outer edge 32b of the second operating piece 32 are inserted through the holding holes 24e and 24f, respectively.

As a result, a space is defined by being surrounded by the holding walls 24a and 24b and the bound article mounting portion 22, and the operating member 18 to be described later in more detail is accommodated movably at an optimal position in this space.

The bound article mounting portion 22 of the holding member 16 includes a first through hole 26 and a second through hole 28 with a prescribed distance therebetween (a distance provided by Japanese Industrial Standard or the like) so that the first and second binding rings 12 and 14 are loosely passed through these holes, respectively.

Each of the first and second through holes 26 and 28 opens at two places separated from each other by a fixed distance on right and left in the width direction of the holding member 16 so as to correspond with binding ring halves 12a and 12b constituting the first binding ring 12 and with binding ring halves 14a and 14b constituting the second binding rings 14.

The operating member 18 preferably includes a pair of operating pieces, namely the first operating piece 30 and the second operating piece 32 each preferably made of a metal plate having a substantially rectangular shape as seen in the plan view.

The first and second operating pieces 30 and 32 are juxtaposed longitudinally in the space of the holding member 16 with the inner edges being linked rotatably. More specifically, respective abutting edges 30a and 32b are caused to abut against each other, and at the same time the outer edges 30b and 32b are joined respectively to the holding walls 24a and 24b of the holding member 16.

One of the operating pieces, or the first operating piece 30 is provided with three cylindrical slide portions 34a, 34b and 34c on the abutting edge 30a for constituting a pivot section (constituting a support for a pivot shaft 38), while the other operating piece, or the second operating piece 32 is provided with three cylindrical slide portions 36a, 36b and 36c on the abutting edge 32a such that these portions are fitted loosely between the cylindrical slide portions 34a, 34b and 34c and together constitute the pivot section (constitute the support for the pivot shaft 38).

Each of the cylindrical slide portions 34a, 34b, 34c and cylindrical slide portions 36a, 36b, 36c preferably has an annular shape in cross section and a through hole is defined in these cylindrical slide portions, so that the through holes of these cylindrical slide portions are aligned with the center line in the longitudinal direction of the holding member 16 and the pivot shaft 38 is passed through these through holes.

A gap 42 is defined between the cylindrical slide portions 34a, 34b, 34c of the first operating piece 30 and the cylindrical slide portions 36a, 36b, 36c of the second operating piece 32, so that the cylindrical slide portions 34a, 34b, 34c of the first operating piece 30 and the cylindrical slide portions 36a, 36b, 36c of the second operating piece 32 are fitted loosely over the pivot shaft 38 constituting the pivot section. In other words, the first operating piece 30 and the second operating piece 32 are designed such that they not only can pivot around the pivot shaft 38 but also move along the axis of the pivot shaft 38.

A gap 44 is formed substantially at the center of the first and second operating pieces 30 and 32 so that an opening/closing member 40 is fitted into this gap.

More specifically, the gap 44 is formed between the cylindrical slide portion 34a of the first operating piece 30 and the cylindrical slide portion 36b of the second operating piece 32 so that the opening/closing member 40 is fitted in this gap.

The inner end of the cylindrical slide portion 34a of one of the operating pieces, or the first operating piece 30 faces the gap 44 for operating/closing member, and the inner end of the cylindrical slide portion 36a of the other operating piece, or the second operating piece 32 also faces the gap 44.

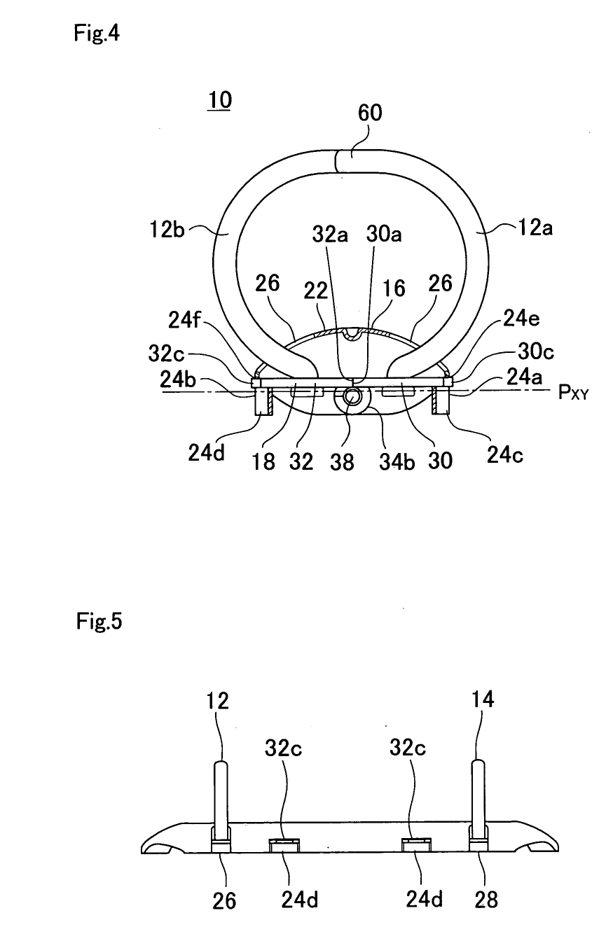

The first and second operating pieces 30 and 32 are arranged within the inner space of the holding member 16, such that when no external force is applied, the operating pieces 30 and 32 lie flat, namely they are separated from the inner surface of the bound article mounting portion 22 of the holding member 16 (the abutting edges 30a and 32a are on a plane substantially parallel to the plane P_{XY} including the bases of the binding ring halves 12a, 12b, 14a and 14b as shown in FIGS. 4 and 7), or such that the first and second operating pieces 30 and 32 are transformed into an inverse V shape arrangement, namely they are brought closer to the inner surface of the bound article mounting portion 22 of the holding member 16 (the abutting edges 30a and 32a are brought above the plane P_{XY} as shown in FIGS. 4 and 7), and the flat state or the inverse V shape arrangement are maintained.

In one of the operating pieces, namely the first operating piece 30 of the operating member 18, the base of the binding ring half 12a constituting the first binding ring 12 is anchored to the surface opposing the inner surface of the bound article mounting portion 22 of the holding member 16 (i.e. the top surface), and the base of the binding ring half 14a constituting the second binding ring 14 is anchored to the same surface but at a certain distance from the binding ring half 12a.

In the other of the operating pieces, namely the second operating piece 32, the base of the binding ring half 12b constituting the first binding ring 12 is anchored to the surface opposing the bound article mounting portion 22 of the holding member 16 (i.e. the top surface), and the base of the binding ring half 14b is anchored to the same surface but at a certain distance from the binding ring half 12b.

When the first and second binding rings 12 and 14 are closed, as shown in FIG. 4, the first and second operating pieces 30 and 32 constituting the operating member 18 are held in the state where the respective abutting edges 30a and 32a of the first and second operating pieces 30 and 32 are separated from the inner surface of the holding member 16 (i.e. the inner surface of the bound article mounting portion 22), and the operating pieces 30 and 32 are oriented to be juxtaposed on a horizontal plane (that is, to form a flat plane together), and the respective abutting edges 30a and 32a abut against each other. When the first and second binding rings 12 and 14 are opened, as shown in FIG. 6, the first and second operating pieces 30 and 32 constituting the operating member 18 are held fixedly in the space of the holding member 16 such that they are oriented towards the inner surface of the holding member 16 (the inner surface of the bound article mounting portion 22) to form an inverse V shape arrangement, and the respective abutting edges 30a and 32a of the first and second operating pieces 30 and 32 abut against the inner surface of the holding member 16.

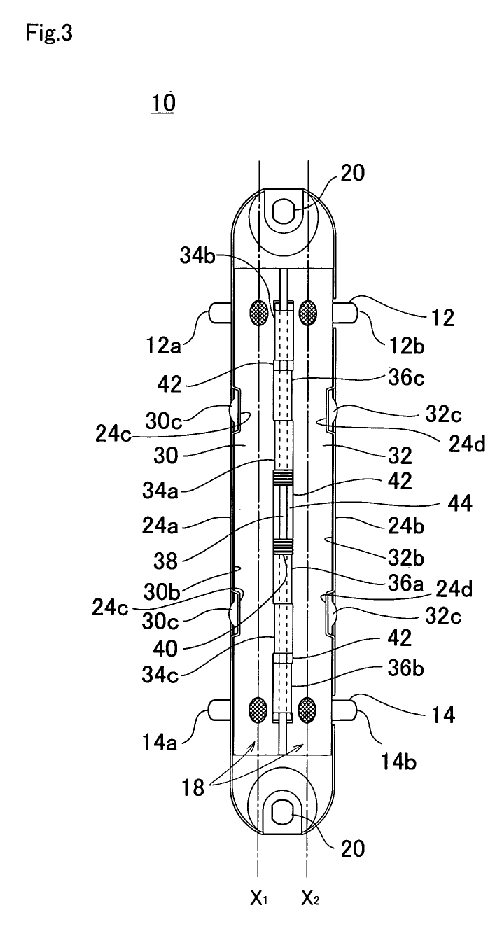

Further, the first and second operating pieces 30 and 32 constituting the operating member 18 are arranged slidably such that, when the operating pieces 30 and 32 are brought closer to the inner surface of the bound article mounting portion 22 of the holding member 16, namely when they are in the inverse V shape arrangement, the first and second operating pieces 30 and 32 can be moved in the longitudinal direction, that is in the direction substantially parallel to the line X₁ connecting the binding ring halves 12a and 14a and the line X₂ connecting the binding ring halves 12b and 14b fixed to the first and second operating pieces 30 and 32 (see FIGS. 3 and 7).

The first and second operating pieces 30 and 32 are provided with the opening/closing member 40 for moving the first and second binding rings 12 and 14 to the opening and closing directions.

The opening/closing member 40 is constituted by a coil spring. This coil spring is preferably constituted by a torsion spring which includes a central linking latch 52 having a substantially U-shape as seen in the plan view, a pair of compression springs 54a and 54b having a substantially cylindrical shape and disposed at the opposite ends of the linking latch 52, a latching portion 56a arranged to be continuous from the end of the compression spring 54a opposite the linking latch 52, and a latching portion 56b arranged to be continuous from the end of the compression spring 54b opposite the linking latch 52, and which is formed into a coil shape by winding steel wire.

The opening/closing member 40 is wound on the pivot shaft 38 of the operating member 18 by passing the pivot shaft 38 through a through hole defined at the center of the substantially cylindrical compression springs 54a and 54b. The linking latch 52 is engaged with and held by the top surface of the first operating piece 30 and the latching portions 56a and 56b are engaged with and held by the top surface of the second operating piece 32.

When the first binding ring 12 is in the closed state, the opening/closing member 40 is twisted and urges the first and second operating pieces 30 and 32 to the direction for opening the first binding ring 12.

One end of opening/closing member 40 on the side of the compression spring 54a wound around the pivot shaft 38 of the operating member 18 and the other end thereof on the side of the compression spring 54b are arranged to be in contact with the cylindrical slide portion 34 of the first operating piece 30 and the cylindrical slide portion 36 of the second operating piece 32, respectively, so that these ends press one of the operating pieces of the operating member 18, or the first operating piece 30 outwards, and the other operating piece of the operating member 18, or the second operating piece 32 outwards, respectively.

When the first binding ring 12 is in the closed state, the compression springs 54a and 54b are, within the space for an opening/closing member 44, in contact with the cylindrical slide portions 34 and 36 to move the first and second operating pieces 30 and 32 longitudinally and outwards along the pivot shaft 38, respectively.

When the first binding ring 12 or the second binding ring 14 is opened by twisting with fingers, the linking latch 52 is once deflected to fill the gaps 42. When the fingers are then relaxed or removed from the binding ring, the linking latch 52 and the compression springs 54a and 54b of the opening/closing member 40 are released from the compression and allowed to extend slightly, urging the first and second operating pieces 30 and 32 to the opposite directions.

The opening/closing member 40 according to this preferred embodiment is thus arranged, within the space of the holding member 16, so as to move the first and second operating pieces 30 and 32 in the opposite direction along the length of the holding member 16, and also to hold the first and second operating pieces 30 and 32 constituting the holding member 16 in the inverse V shape arrangement, namely in the state where the abutting edge 30a of the first operating piece 30 and the abutting edge 32a of the second operating piece 32 are brought closer to the inner surface of the bound article mounting portion 22 of the holding member 16.

When the first and second binding rings 12 and 14 thus start being opened, in other words when respective latching portions 60 of the first and second binding rings 12 and 14 are disengaged with fingers, the opening/closing member 40 that has been compressed, exerts restoring action in its attempt to restore to its original state on the first and second binding rings 12 and 14 such that the binding ring halves 12a and 12b of the first binding ring 12 are separated from each other (the binding ring half 12a is moved to the direction O₁ while the binding ring half 12b is moved to the direction O₂ (see FIG. 7)) and the binding ring halves 14a and 14b are separated from each other (the binding ring half 14a is moved to the direction O₁ while the binding ring half 14b is moved to the direction O₂ (see FIG. 7)). Thus, the first and second operating pieces 30 and 32 are urged to move in the opposite directions.

As a result, the first operating piece 30 is moved in the direction to disengage the binding ring latching portions 60 of the first binding ring 12 (in the direction O₁) and the second operating piece 32 is moved in the direction to disengage the binding ring latching portions 60 of the second binding ring 14 (in the direction O₂).

Further, the opening/closing member 40, that has been twisted, exerts action, in the attempt to restore to its original state, such that the binding ring halves 12a and 12b as well as the binding ring halves 14a and 14b are separated from each other in the circumferential direction (in the directions Y₁ and Y₂ (see FIG. 7)).

The first and second operating pieces 30 and 32 constituting the operating member 18 are transformed from the flat state to the inverse V shape arrangement.

When the first and second binding rings 12 and 14 are in the opened state, the opening/closing member 40 exerts action such that the first and second operating pieces 30 and 32 are held in the inverse V shape arrangement, namely the abutting edge 30a of the first operating piece 30 and the abutting edge 32a of the second operating piece 32 are raised to the proximity of the inner surface of the bound article mounting portion 22 of the holding member 16.

The first binding ring 12 preferably includes the pair of semi-circular binding ring halves 12a and 12b to form a substantially annular shape. The second binding ring 14 also includes the pair of semi-circular binding ring halves 14a and 14b to form a substantially annular shape. The first and second binding rings 12 and 14 are provided with the latch portion 60 at the tip ends of the binding ring halves 12a and 12b and of the binding ring halves 14a and 14b, so that a sheet P can be bound by passing the binding rings through binding holes pre-formed in the sheet P and latching the respective latch portions 60.

The binding ring halves 12a and 12b constituting the first binding ring 12 are engaged together, forming an annular shape, by engaging the respective latch portions 60 of the binding ring halves 12a and 12b with each other.

The binding ring halves 14a and 14b constituting the second binding ring 14 are also engaged together, forming an annular shape, by engaging the respective latch portions 60 of the binding ring halves 14a and 14b with each other.

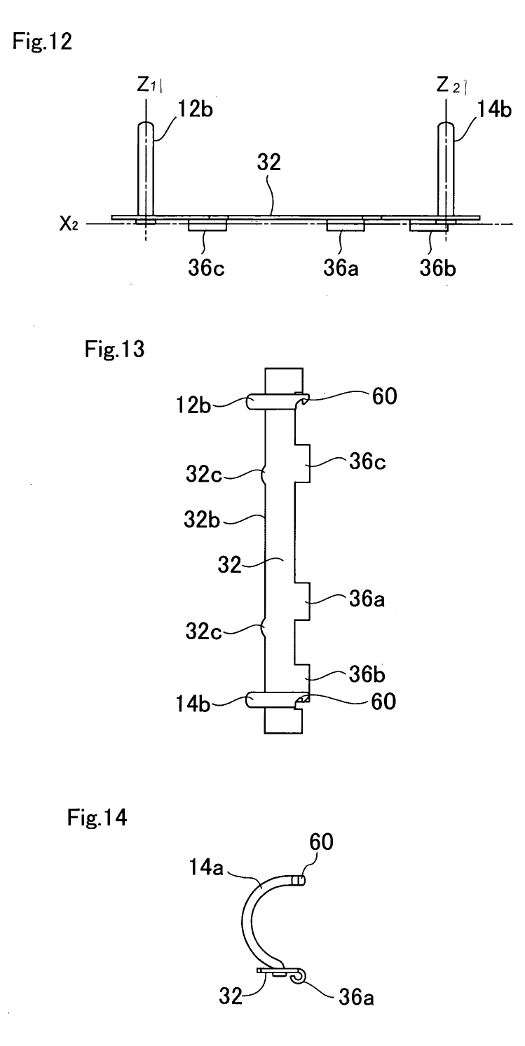

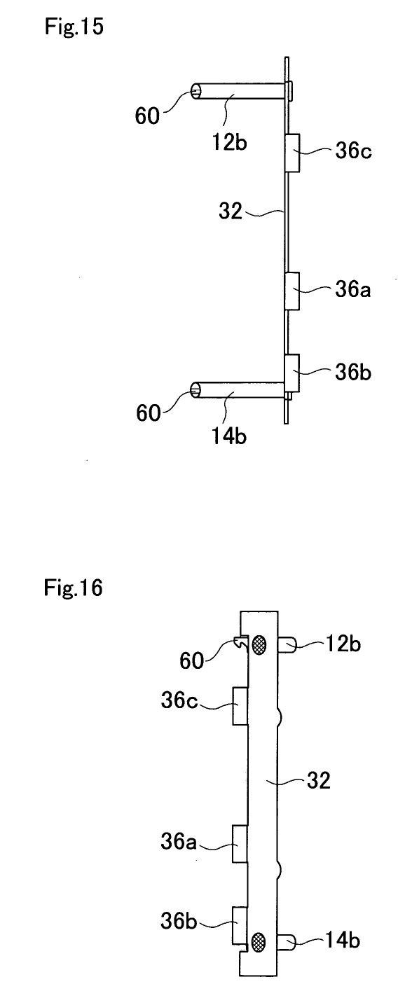

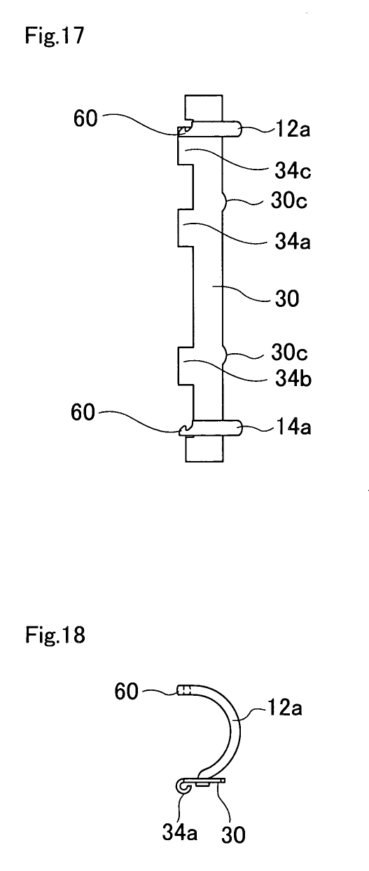

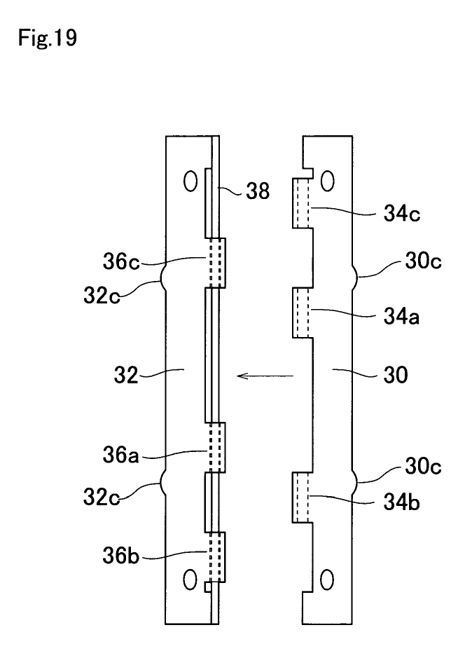

The first and second binding rings 12 and 14 are arranged to stand erect from the first and second operating pieces 30 and 32 so as to each define a plane that is substantially perpendicular to the plane P_{XY} including the axes Y₁ and Y₂ and the axes X₁ and X₂ passing respectively the two points (four points in total) where the bases of the first and second binding rings 12 and 14 are anchored to the first and second operating pieces 30 and 32 (see FIGS. 4 and 7). The circular plane defined by the axis Z₁ of the first binding ring 12 (see FIG. 12) and the circular plane defined by the axis Z₂ of the second binding ring 14 (see FIG. 12) are substantially parallel with each other and substantially perpendicular to the plan P_{XY} including the points where the first and second binding rings 12 and 14 are anchored to the first and second operating pieces 30 and 32.

The first and second binding rings 12 and 14 are thus arranged such that the respective binding ring latching portions 60 can be disengaged in the same direction using fingers.

The binding ring latching portion 60 disposed at the tip end of the binding ring half 12a constituting the first binding ring 12 includes a projection 62a and a recess 62b following this projection 62a at the tip end thereof, and the binding ring latching portion 60 disposed at the tip end of the binding ring half 12b includes a projection 64a and a recess 64b following this projection 64a at the tip end thereof. The projections 62a and 64a are arranged to project in mutually opposite directions, and the recesses 64b and 64b are recessed in mutually opposite directions, so that they engage with each other when the first binding ring 12 is closed. The projections 62a and 64a are each provided with a sloping edge extending inwards from the tip end, so that the first and second binding rings 12 and 14 can be opened/closed, by sliding along these sloping edges.

In a similar manner, the binding ring latching portion 60 disposed at the tip end of the binding ring half 14a constituting the second binding ring 14 includes a projection 66a and a recess 66b following this projection 66a at the tip end thereof, and the binding ring latching portion 60 disposed at the tip end of the binding ring half 14b includes a projection 68a and a recess 68b following this projection 68a at the tip end thereof. The projections 66a and 68a are arranged to project in mutually opposite directions, and the recesses 66b and 68b are recessed in mutually opposite directions, so that they engage with each other when the first binding ring 14 is closed.

Further, the projection 62a constituting the binding ring latching portion 60 of the binding ring half 12a and the projection 66a constituting the binding ring latching portion 60 of the binding ring half 14a are arranged to project in the same direction.

Similarly, the recess 64b constituting the binding ring latching portion 60 of the binding ring half 12b and the recess 68b constituting the binding ring latching portion 60 of the binding ring half 14b are arranged to be recessed in the same direction.

Accordingly, the binding ring latching portion 60 of the first binding ring 12 can be disengaged by twisting the top of the first binding ring 12 with fingers. When the binding ring latching portion 60 of the first binding ring 12 is thus disengaged with fingers, the first and second operating pieces 30 and 32 are subjected to a force generated by the opening/closing member 40 to recover the original state, or to expand, and are urged to move in the opposite directions. The restoring force of the opening/closing member 40 that has been twisted acts in the direction to separate the projection 66a of the binding ring half 14a constituting the second binding ring 14 from the projection 68a of the binding half 14b, and also in the direction to separate the projection 62a of the binding ring half 12a constituting the first binding ring 12 from the projection 64a of the binding ring half 12b.

According to this preferred embodiment, therefore, it is possible to disengage the binding ring latching portions 60 of the binding ring halves 12a and 12b of the first binding ring 12 and the binding ring latching portions 60 of the binding ring halves 14a and 14b of the second binding ring 14 just by twisting the top parts of the first and second binding rings 12 and 14 with fingers.

The binder 10 can be attached to the cover A by using bolts and nuts through the attaching holes 20, with the bottom edges of the holding walls 24a and 24b joined to the cover. Optionally, a spacer may be interposed to provide a space therebetween.

The preferred embodiment as described above relates to a 2-hole type binder, having two binding rings such as the first and second binding rings 12 and 14. However, a biding device according to preferred embodiments of the present invention may be provided with more binding rings, for example with 3, 4, 20, 26 or 30 binding rings.

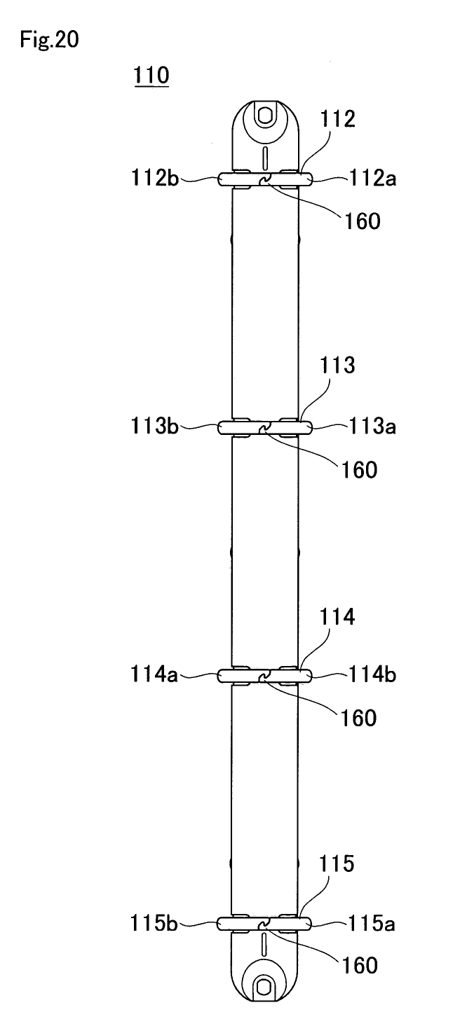

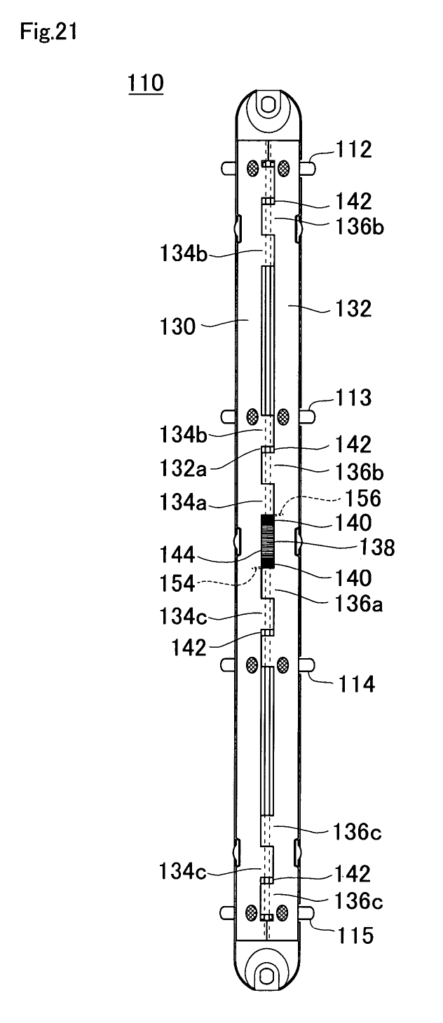

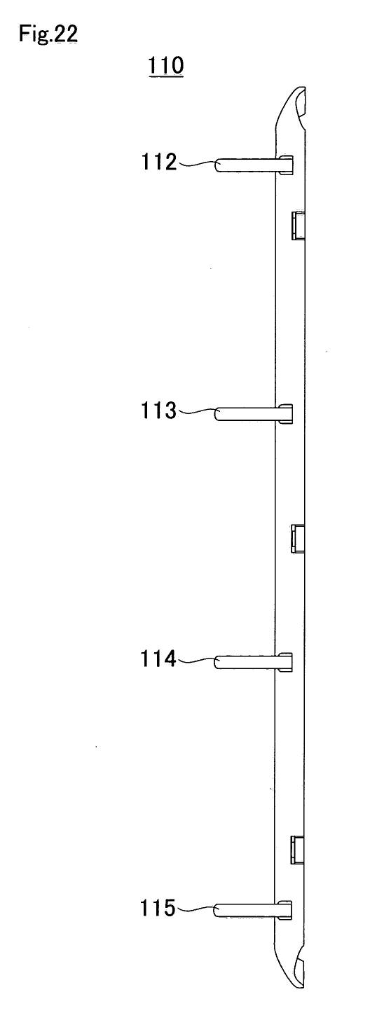

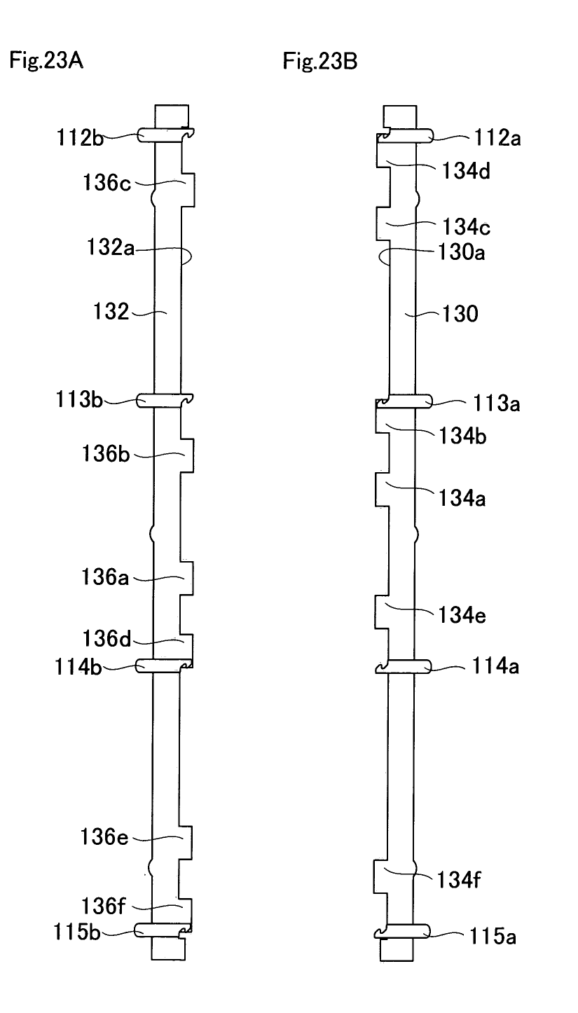

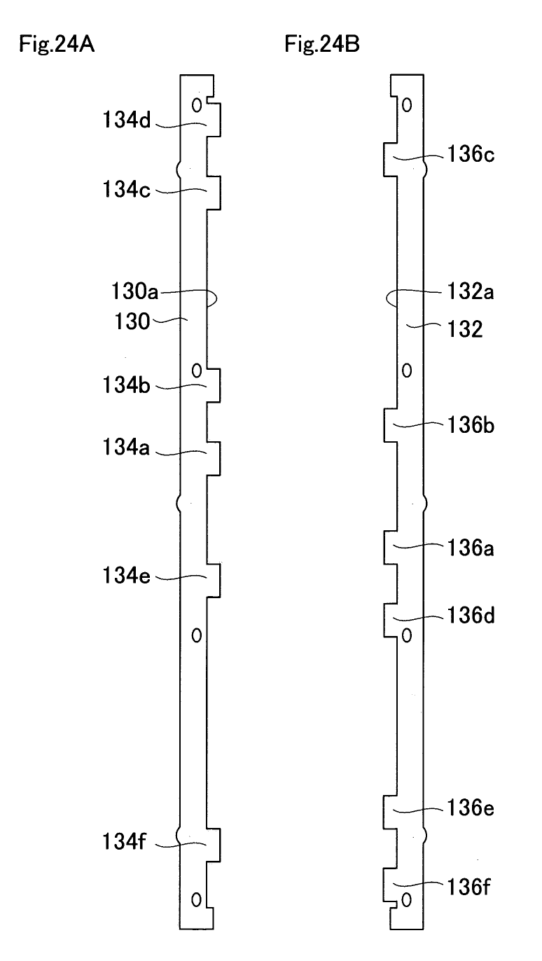

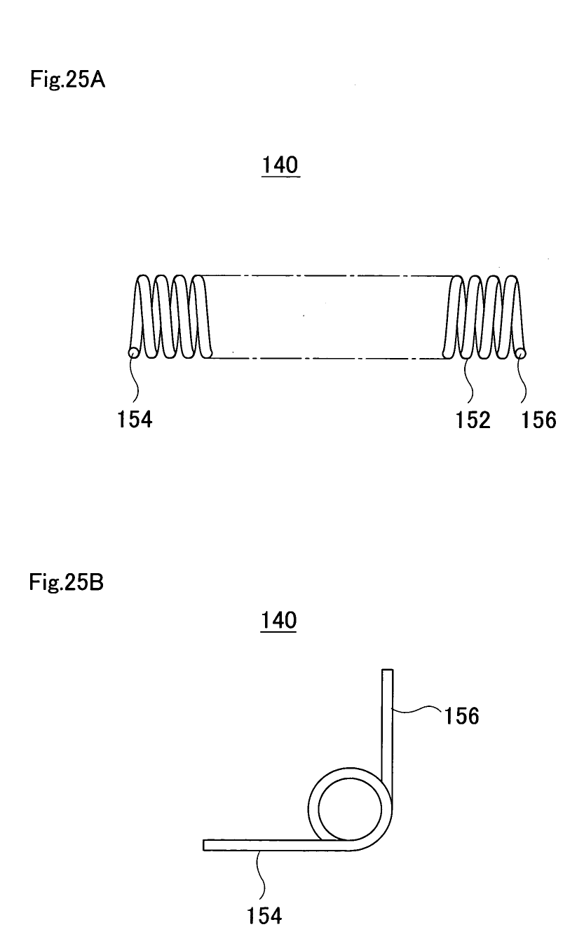

An alternative preferred embodiment of the present invention will be described with reference to FIGS. 20 through 25.

A binder 110 according to this preferred embodiment has a constitution that is preferably similar to that of the binder 10 of the first preferred embodiment described above, with an exception that configurations of operating and an opening/closing members differ from that of the first preferred embodiment due to the increased number of binding rings. The following description will be focused on these different configurations.

The binder 110 is of 4-hole type and includes four binding rings including a first binding ring 112, a second binding ring 113, a third binding ring 114, and a fourth binding ring 115. The first binding ring 112 includes binding ring halves 112a and 112b, the second binding ring 113 includes binding ring halves 113a and 113b, the third binding ring 114 includes binding ring halves 114a and 114b, and the fourth binding ring 115 includes binding ring halves 115a and 115b.

A first operating piece 130 to which the bases of the binding ring halves 112a, 113a, 114a and 115a are anchored and a second operating piece 132 to which the bases of the binding ring halves 112b, 113b, 114b and 115b are anchored are arranged to extend longer than the first and second operating pieces 30 and 32 of the first preferred embodiment. The first to fourth binding rings 112 to 115 are arranged to stand erect while being separated from each other with an interval according to the relevant provision of Japanese Industrial Standards.

The first and second operating pieces 130 and 132 are caused to abut against each other at the respective abutting edges 130a and 132a. Cylindrical slide portions 136a, 136b, 136c, 136d, 136e and 136f of the second operating piece 132 are fitted in between cylindrical slide portions 134a, 134b, 134c, 134d, 134e and 134f of the first operating piece 130, and thus the cylindrical slide portions 134a, 134b, 134c, 134d, 134e and 134f of the first operating piece 130 and the cylindrical slide portions 136a, 136b, 136c, 136d, 136e and 136f of the second operating piece 132 are aligned linearly, defining a through hole therein. A pivot shaft 138 is fitted in the through hole so that the operating pieces 130 and 132 are pivotable around the pivot shaft 138.

A gap 142 is defined between the cylindrical slide portions 134 of the first operating piece 130 and the cylindrical slide portions 136 of the second operating piece 132.

A gap for an opening/closing member 144 is formed substantially at the center of the abutting edge 130a of the first operating piece 130, and a gap for an opening/closing member 144 is formed substantially at the center of the abutting edge 132a of the first operating piece 132.

The cylindrical slide portion 134a disposed on the abutting edge 130a of the first operating piece 130 faces the gap 144 for an opening/closing member, and the cylindrical slide portion 136a disposed on the abutting edge 132a of the first operating piece 132 faces the gap 144 for an opening/closing member on the opposite side from the first operating piece 130.

An opening/closing member 140 is constructed in a slightly different manner from the opening/closing member 40 constituted by the coil spring according to the first preferred embodiment, and the opening/closing member 140 is coiled as a whole into a substantially cylindrical shape.

The opening/closing member 140 has a latch 154 and a latch 156 provided at the opposite ends of the substantially cylindrical coil 152 in continuation therefrom so as to be directed toward the opposite directions. The opening/closing member 140 is fitted in the gap for an opening/closing member 144 by inserting the pivot shaft 138 through the through hole within the substantially cylindrical coil 152, while the latch 154 is engaged with and held by the rear surface of the first operating piece 130 and, when the binding rings are closed, the latch 156 is engaged with and held by the top surface of the second operating piece 132 with the opening/closing member 140 being twisted.

The substantially cylindrical coil 152 is fitted in the gap 144 for an opening/closing member in a state where it is compressed and therefore exerts an elastic force in its attempt to expand, with one end thereof abutting against the edge of the cylindrical slide portion 134a of the first operating piece 130 on the side of the gap 144 for an opening/closing member and the other end being in contact with the edge of the cylindrical slide portion 136a of the second operating piece 132 on the side of the gap 144 for an opening/closing member.

According to this preferred embodiment, therefore, binding ring latching portions 160 of the first, second, third and fourth binding rings 112, 113, 114 and 115 can be disengaged simply by twisting with fingers the top parts of two of the first to fourth binding rings 112 to 115.

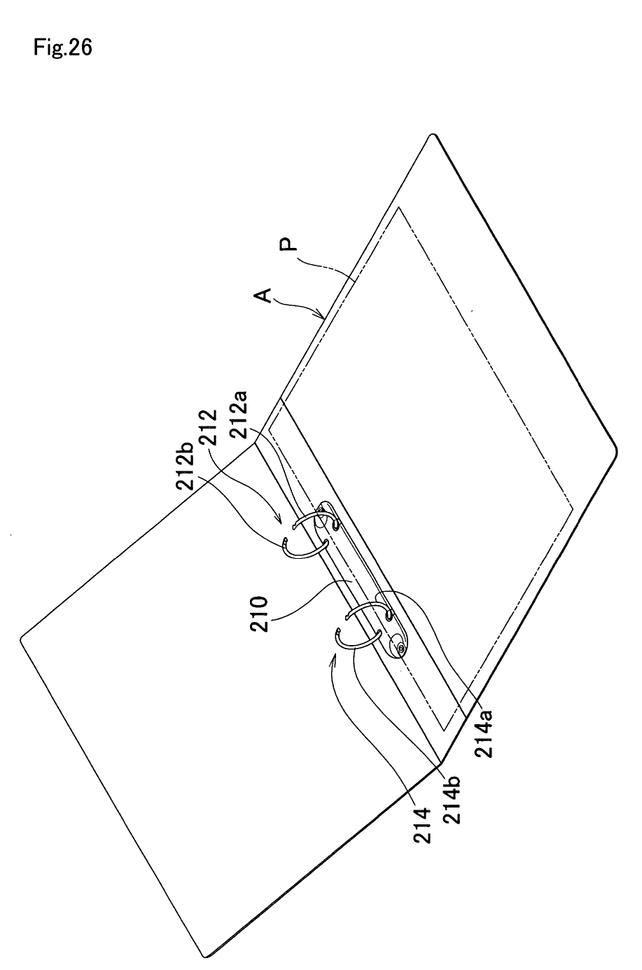

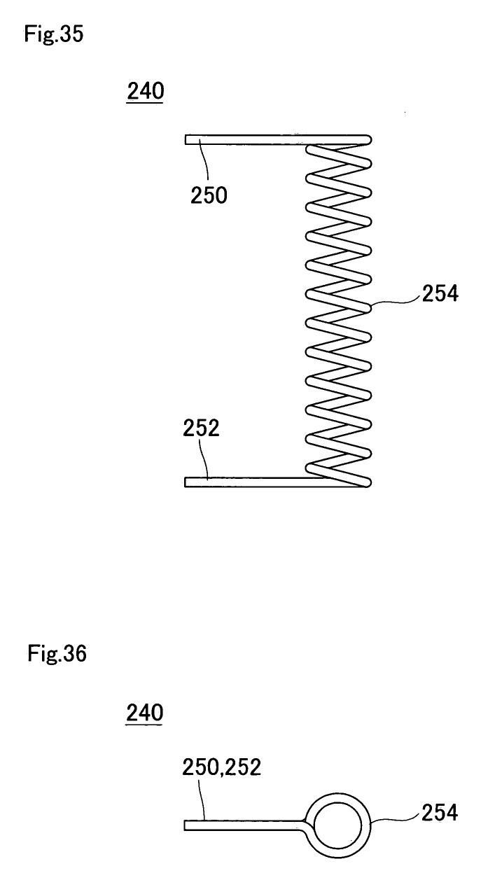

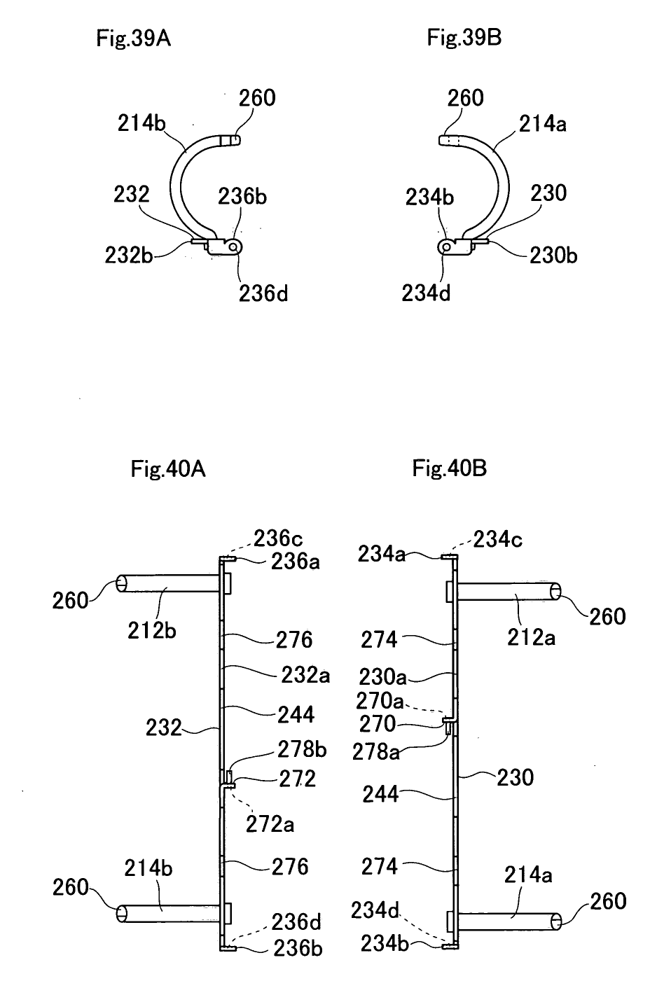

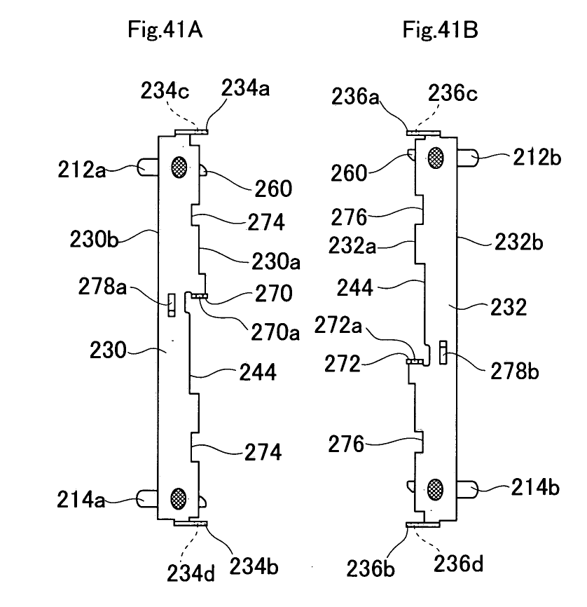

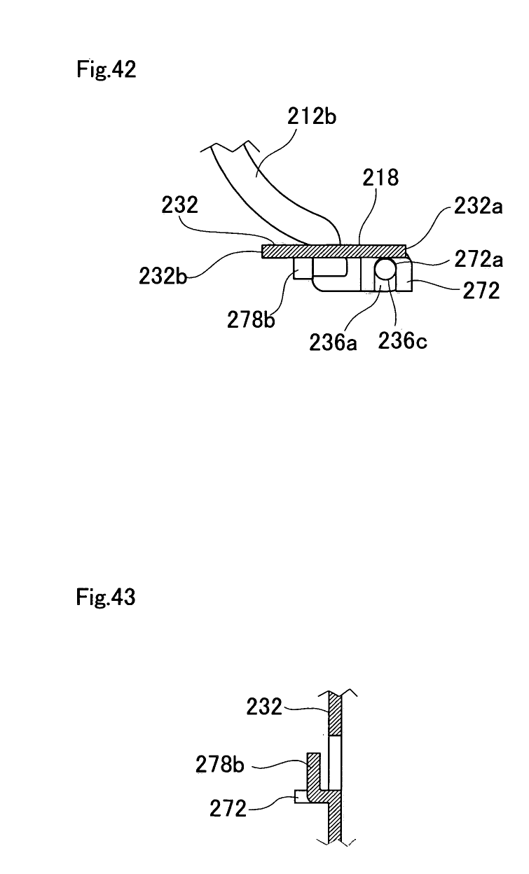

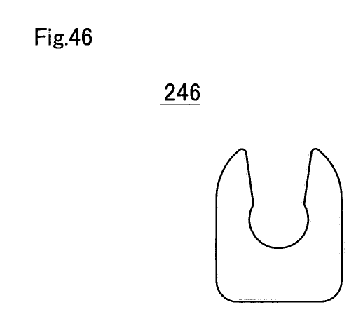

Next, a further preferred embodiment according to the present invention will be described with reference to FIGS. 26 through 46.

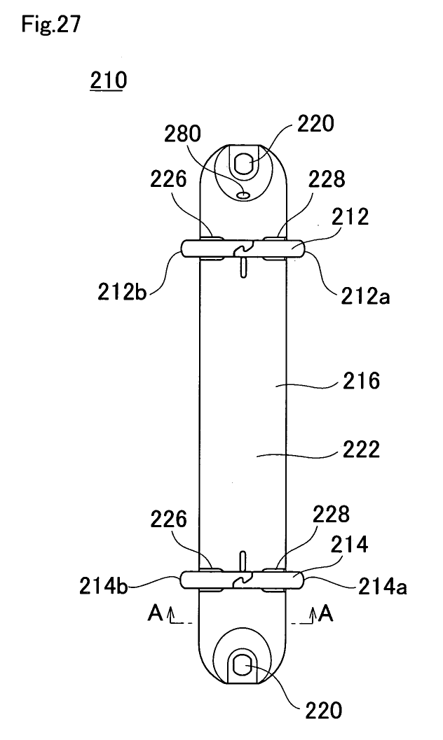

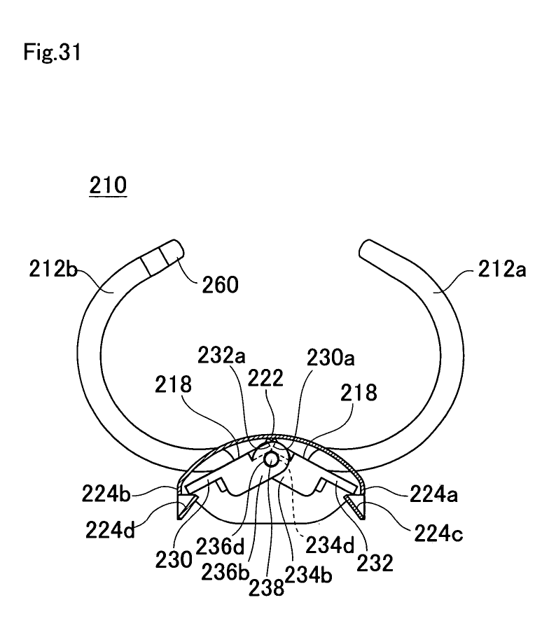

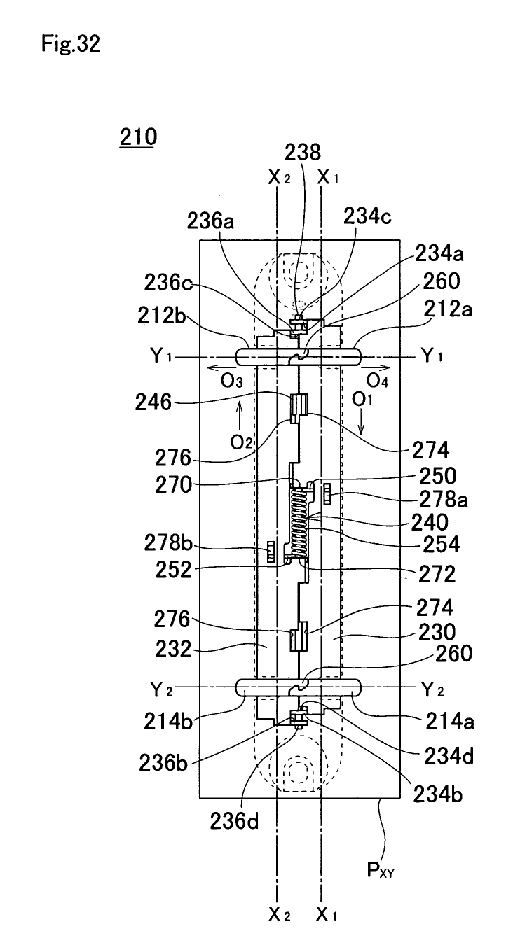

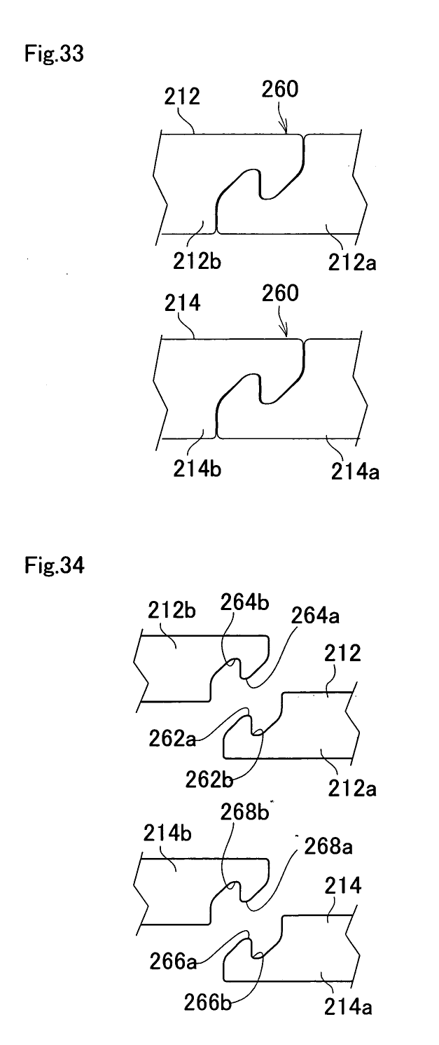

FIG. 26 is a perspective view showing a binder according to the further preferred embodiment of the present invention. FIGS. 27, 28, 29, and 30 are a plan view, a bottom view, a cross-sectional view, and a side view showing the binder in the closed state, respectively. FIG. 31 is a cross-sectional view of the binder in the opened state. FIG. 32 is a plan view illustrating the binding rings and operating member in the closed state. FIG. 33 is a plan view illustrating the vicinity of a binding ring latching portion in the closed state, and FIG. 34 is a plan view illustrating the vicinity of the tip ends of binding ring halves in the opened state.

A binder 210 is fixed to the inner surface of a back cover between a pair of left and right fold lines formed substantially at the center of a cover A preferably made of a relatively rigid sheet material such as card board or other suitable material. The binder 210 may be fixed integrally with the back cover by inserting fasteners such as bolts and nuts or eyelets through attaching holes 220 (to be described later) formed at the opposite ends in the longitudinal direction of the binder 210.

It should be noted that, although description is made herein using bolts and nuts as the fasteners, the fasteners are not restricted thereto but other means such as screws, eyelets, or rivets also may be used. Further, it is also possible to adopt a supersonic welding or high-frequency welding technique to fasten the binder.

The binder 210 preferably includes a pair of first and second binding rings 212 and 214 preferably made of a metal and having a substantially annular shape, a holding member 216 having a sufficient length to allow the first and second binding rings 212 and 214 to be arranged with an appropriate interval therebetween, and an operating member 218 which is attached movably to the inside of the holding member 216 such that bases of the first and second binding rings 212 and 214 are anchored to the surface thereof with a distance from each other and thus the first and second binding rings 212 and 214 are fixed to the holding member 216.

The holding member 216 is preferably substantially rectangular as seen in the plan view, having a sufficient length to allow the first and second binding rings 212 and 214 to be arranged with an appropriate interval therebetween, and is formed into a substantially semi-circular shape in the plan view at the opposite ends, in other words at the parts around attaching holes 220 for attaching the holding member 216 to the cover A.

The holding member 216 has a bound article mounting portion 222 which extends transversely from outside the positions where the first and second binding rings 212 and 214 are fixed and bulges out at the center to have a substantially semi-circular cross section. The holding member 216 also has a space inside this bound article mounting portion 222 so as to accommodate the operating member 218 and so on.

The bound article mounting portion 222 of the holding member 216 is provided with holding walls for holding the operating member 218 movably, such that the holding walls extend longitudinally along the edges substantially from one end to the other end of the bound article mounting portion 222. In this preferred embodiment, a holding wall 224a and a holding wall 224b are arranged longitudinally substantially over the whole length of the holding member 216 inwardly from outside the first binding ring 212 and from outside the second 214 binding ring 214, and so as to extend downwards. Further, holding projections 224c and holding projections 224d are provided to the holding wall 224a and holding wall 224b, respectively, with an appropriate distance from each other, such that these projections project inwards from the lower edges of the holding walls 224a and 224b. These holding projections 224c and 224d are for holding a first operating piece 230 and a second operating piece 232 at the vicinities of the respective outer edges 230b and 232b.

As a result, a space is defined by being surrounded by the holding walls 224a and 224b and the bound article mounting portion 222, and the operating member 218 to be described later in more detail is accommodated movably at an optimal position in this space.

The bound article mounting portion 222 of the holding member 216 includes a first through hole 226 and a second through hole 228 with a prescribed distance therebetween (a distance provided by Japanese Industrial Standard or the like) so that the first and second binding rings 212 and 214 are loosely passed through these holes, respectively.

Each of the first and second through holes 226 and 228 opens at two places separated from each other by a fixed distance on right and left in the width direction of the holding member 216 so as to correspond with binding ring halves 212a and 212b constituting the first binding ring 212 and with binding ring halves 214a and 214b constituting the second binding rings 214.

The operating member 218 preferably includes a pair of operating pieces, namely the first operating piece 230 and the second operating piece 232 each made of a metal plate having a substantially rectangular shape as seen in the plan view.

The first and second operating pieces 230 and 232 are identical in shape, and are juxtaposed longitudinally in the space of the holding member 216 in point symmetry with the inner edges being linked rotatably. More specifically, respective abutting edges 230a and 232a are caused to abut against each other, and at the same time the outer edges 230b and 232b are joined respectively to the holding walls 224a and 224b of the holding member 216.

At the opposite ends of the abutting edge 230a of one of the operating pieces, or the first operating piece 230, namely at one end that is substantially perpendicular to the abutting edge 230a and the other end opposite the one end of the operating piece 230, pivot shaft pieces 234a and 234b constituting a pivot shaft portion (constituting a section for pivotably supporting the pivot shaft 238) are arranged to protrude vertically to the abutting edge 230a by folding the opposite ends of the abutting edge 230a.

These pivot shaft portions 234a and 234b are arranged to face each other across the abutting edge 230a and to be substantially parallel with each other, and include pivot shaft holes 234c and 234d respectively, substantially at the center thereof, so that the pivot shaft 238 constituting the pivot shaft portion is passed through these holes.

At the opposite ends of the abutting edge 232a of one of the operating pieces, or the second operating piece 232, namely at one end that is substantially perpendicular to the abutting edge 232a and the other end opposite the one end of the operating piece 232, pivot shaft pieces 236a and 236b constituting a pivot shaft portion (constituting a section for pivotably supporting the pivot shaft 238) are arranged to protrude vertically to the abutting edge 232a by folding the opposite ends of the abutting edge 232a.

These pivot shaft portions 236a and 236b are arranged to face each other across the abutting edge 232a and to be substantially parallel with each other, and include pivot shaft holes 236c and 236d respectively, substantially at the center thereof, so that the pivot shaft 238 is passed through these holes.

The first and second operating pieces 230 and 232 are juxtaposed with each other, and are provided within the holding member 216 such that the pivot shaft piece 234a of the first operating piece 230 and the pivot shaft piece 236a of the second operating piece 232 are overlapped substantially in parallel with a gap therebetween, and the pivot shaft piece 234b of the first operating piece 230 and the pivot shaft piece 236b of the second operating piece 232 are overlapped substantially in parallel with a gap therebetween. The pivot shaft holes 236c and 236d are aligned on the longitudinal center line of the holding member 216.

The first and second operating pieces 230 and 232 are provided, substantially at the center thereof, with a gap 244 for an opening/closing member in which an opening/closing member 240 is fitted.

The inner end of a pivot shaft bearing 270 of one of the operating pieces, or the first operating piece 230 faces the gap 244 for an opening/closing gap, and the inner end of a pivot shaft bearing 272 of the other operating piece, or the second operating piece 232 faces the gap 244 in opposition to the inner end of the pivot shaft bearing 270.

The pivot shaft bearing 270 of the first operating piece 230 and the pivot shaft bearing 272 of the second operating piece 232 are preferably formed by folding the first and second operating pieces 230 and 232 towards the rear side, and provided with semi-circular recesses 270a and 272a, respectively, at the tip ends thereof, so that the pivot shaft 238 is fitted in these recesses.

Further, a gap 274 for holding the pivot shaft 238 is formed in the abutting edge 230a of the first operating piece 230 and a gap 276 for holding the pivot shaft 238 is formed in the abutting edge 232a of the second operating piece 232 such that these gaps 274 and 276 face each other.

The pivot shaft holding gaps 274 and 276 face each other and form a substantially square through hole.

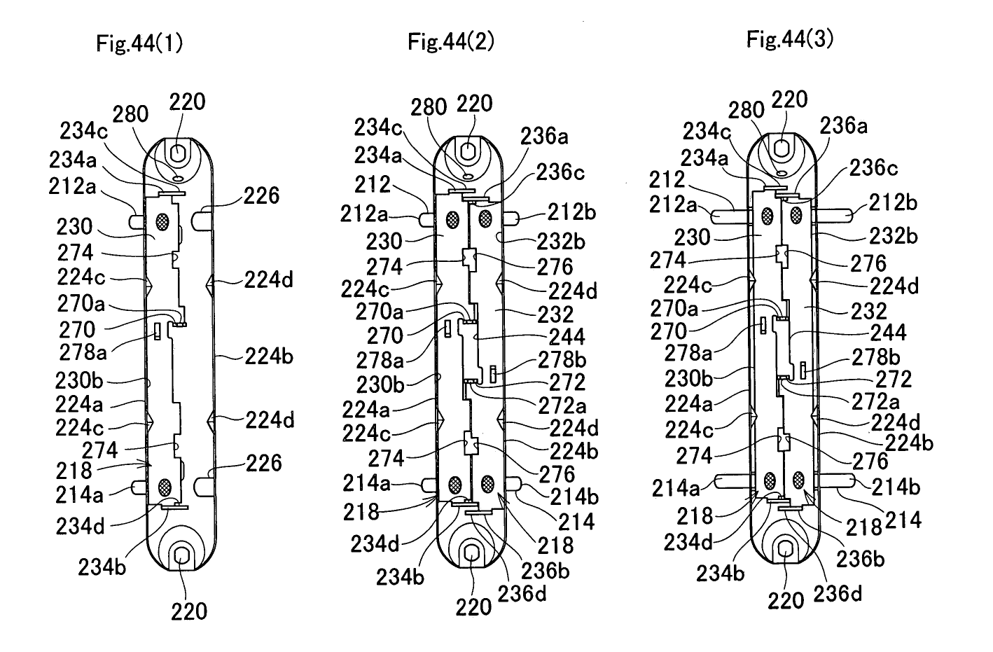

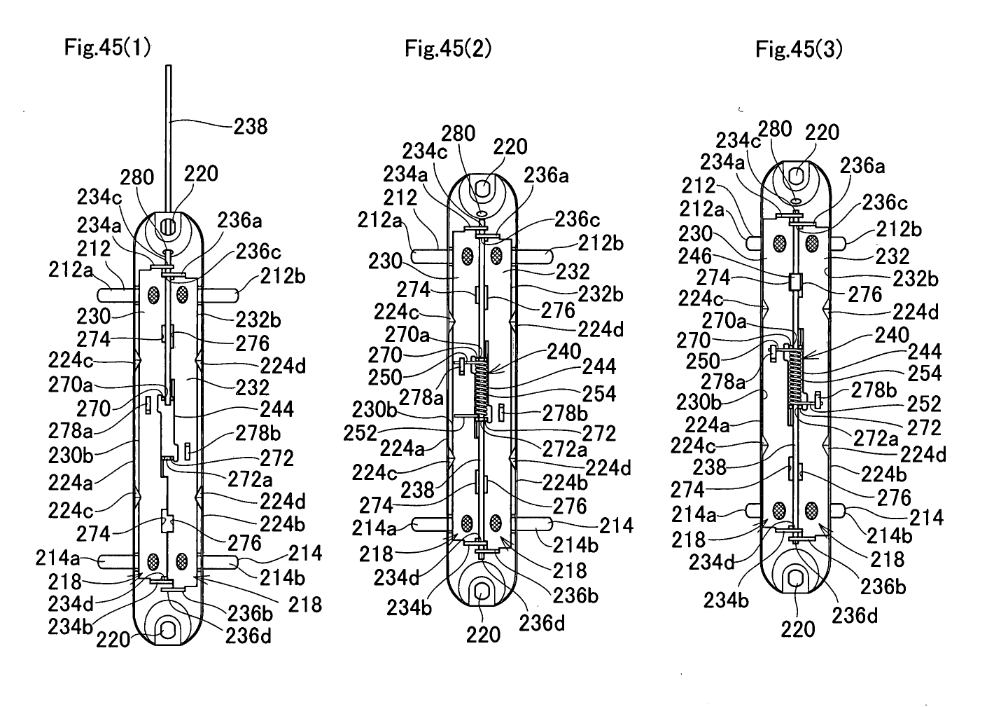

The binder 210 can be assembled according to the following procedures as shown in FIGS. 44 and 45.

One of the operating pieces constituting the operating member 218, or the first operating piece 230 to which one of bases of each of the first and second binding rings 212 and 214 is fixed, and the other operating piece, or the second operating piece 232 to which the other of the bases of each of the first and second binding rings 212 and 214 is fixed are juxtaposed with each other within the holding member 216 such that the operating pieces 230 and 232 can be moved in the longitudinal direction of the holding member 216 in the order of (1), (2) and (3) in FIG. 44 (a step of juxtaposing the operating pieces).

The pivot shaft 238 constituting the pivot shaft portion is fixed to the pivot shaft portion of the first and second operating pieces 230 and 232.

The bound article mounting portion 222 of the holding member 216 includes a pivot shaft insertion hole 280 at an inner side of the attaching hole 220 so that the pivot shaft 238 is inserted through this hole 280. As shown in FIG. 45(1), the pivot shaft 238 is inserted from the pivot shaft insertion hole 280 in the holding member 216 through the pivot shaft hole 234c in the pivot shaft piece 234a of the first operating piece 230 and through the pivot shaft hole 236c in the pivot shaft piece 236a of the second operating piece 232 juxtaposed with the first operating piece within the holding member 216 (a step of inserting the pivot shaft). Since the pivot shaft holes 234c and 236c and the pivot shaft holes 234d and 236d are formed in the holding member 216 so as to align substantially linearly, the pivot shaft 238 can be passed through these holes easily.

As shown in FIG. 45(2), the pivot shaft 238 is then passed through the holding gaps 274 and 276 and through the gap 244 for an opening/closing member, and further passed through the through hole in the compression spring 254 of the opening/closing member 240 fitted in the gap 244 for an opening/closing member (a step of fixing the opening/closing member).

Further, the pivot shaft 238 is passed through the holding gaps 274 and 276 and through the pivot shaft hole 236d in the pivot shaft piece 236b of the second operating piece 232 and the pivot shaft hole 234d in the pivot shaft piece 234b of the first operating piece 230 (a step of inserting the pivot shaft).

When passing the pivot shaft 238 in this manner, the pivot shaft 238 is fitted in the semi-circular recesses 270a and 272a of the pivot shaft bearings 270 and 272.

The opening/closing member 240 preferably includes a coil spring, which is generally constituted by a torsion spring. The opening/closing member 240 is preferably formed by winding steel wire into a coil and includes a substantially cylindrical compression spring 254, a latch 250 extending from an end of the compression spring 254, and another latch 252 extending from the opposite end of the compression spring 254. As shown in FIGS. 45(2) and 45(3), the latch 250 is engaged with and held by the latching portion 278a on the upper surface of the first operating member 230 and the other latch 252 is engaged with and held by the latching portion 278b on the upper surface of the second operating piece 232.

As shown in FIG. 45(3), a substantially U-shaped stopper 246 having elasticity is attached to the outer surface of the pivot shaft 238 passed through the pivot shaft holding gaps 274 and 276 to prevent the pivot shaft 238 from coming out.

The opening/closing member 240 is fitted in the gap 244 for an opening/closing member of the operating member 218 which will be described later in more detail, and held in the twisted state by the first and second operating pieces 230 and 232.

The pivot shaft pieces 234a and 234b of the first operating piece 230 and the pivot shaft pieces 236a and 236b of the second operating piece 232 are preferably formed from the same metallic plate forming the first and second operating pieces 230 and 232 in continuation from these first and second operating pieces 230 and 232, by folding the plate substantially perpendicularly to the planar bodies of the first and second operating pieces 230 and 232. In this manner, the pivot shaft pieces 234a and 234b are arranged to face each other, and the pivot shaft pieces 236a and 236b are also arranged to face each other. The pivot shaft holes 234c and 234d and the pivot shaft holes 236c and 236d formed in these pivot shaft pieces are thus aligned linearly, making it easy to pass the straight pivot shaft 238 through these holes.

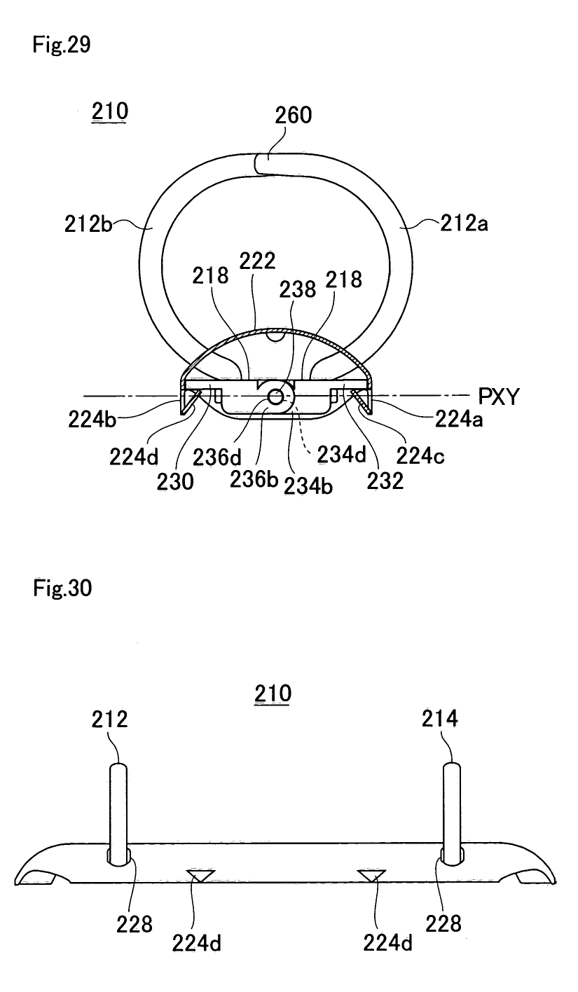

The first and second operating pieces 230 and 232 are arranged within the inner space of the holding member 216, such that when no external force is applied they lie flat, namely they are separated from the inner surface of the bound article mounting portion 222 of the holding member 216 (the abutting edges 230a and 232a are on a plane substantially parallel to the plane P_{XY} including the bases of the binding ring halves 212a, 212b, 214a and 214b as shown in FIGS. 29 and 32), or such that the first and second operating pieces 230 and 232 are transformed into an inverse V shape arrangement, namely they are brought closer to the inner surface of the bound article mounting portion 222 of the holding member 216 (the abutting edges 230a and 232a are brought above the plane P_{XY} as shown in FIGS. 29 and 32), and the flat state or the inverse V shape arrangement are maintained.

In one of the operating pieces, namely the first operating piece 230 of the operating member 218, the base of the binding ring half 212a constituting the first binding ring 212 is anchored to the surface opposing the inner surface of the bound article mounting portion 222 of the holding member 216 (i.e. the top surface), and the base of the binding ring half 214a constituting the second binding ring 214 is anchored to the same surface but at a certain distance from the binding ring half 212a.

In the other of the operating pieces, namely the second operating piece 232, the base of the binding ring half 212b constituting the first binding ring 212 is anchored to the surface opposing the bound article mounting portion 222 of the holding member 216 (i.e. the top surface), and the base of the binding ring half 214b is anchored to the same surface but at a certain distance from the binding ring half 212b.

When the first and second binding rings 212 and 214 are closed, as shown in FIG. 29, the first and second operating pieces 230 and 232 constituting the operating member 218 are held in the state where the respective abutting edges 230a and 232a of the first and second operating pieces 230 and 232 are separated from the inner surface of the holding member 216 (i.e. the inner surface of the bound article mounting portion 222), and the operating pieces 230 and 232 are oriented to be juxtaposed on a horizontal plane (that is, to form a flat plane together), and the respective abutting edges 230a and 232a abut against each other. When the first and second binding rings 212 and 214 are opened, as shown in FIG. 31, the first and second operating pieces 230 and 232 constituting the operating member 218 are held fixedly in the space of the holding member 216 such that they are oriented towards the inner face of the holding member 216 (the inner surface of the bound article mounting portion 222) to form an inverse V shape arrangement, and the respective abutting edges 230a and 232a of the first and second operating pieces 230 and 232 abut against the inner surface of the holding member 216.

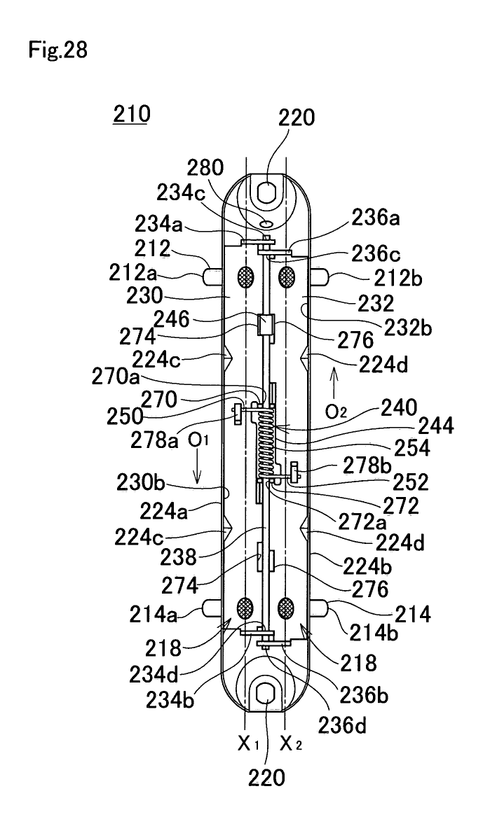

Further, the first and second operating pieces 230 and 232 constituting the operating member 218 are slidably mounted such that, when the operating pieces 230 and 232 are brought closer to the inner surface of the bound article mounting portion 222 of the holding member 216, namely when they are in the inverse V shape arrangement, the first and second operating pieces 230 and 232 can be moved in the longitudinal direction, that is in the direction that is substantially parallel to the line X₁ connecting the binding rings halves 212a and 214a and the line X₂ connecting the binding ring halves 212b and 214b fixed to the first and second operating pieces 230 and 232 (see FIGS. 28 and 32).

The first and second operating pieces 230 and 232 are provided with the opening/closing member 240 for moving the first and second binding rings 212 and 214 to the opening and closing directions.

The opening/closing member 240 is constituted by a coil spring, which is preferably a torsion spring. The opening/closing member 240 is preferably formed by winding steel wire into a coil, and includes a substantially cylindrical compression spring 254, a latch 250 extending from an end of the compression spring 254 and a latch 252 extending from the opposite end of the compression spring 254.

The opening/closing member 240 is thus wound on the pivot shaft 238 of the operating member 218 by inserting the pivot shaft 238 through the through hole formed at the center of the substantially cylindrical compression spring 254. The latch 250 is engaged with and held by the latching portion 278a on the upper surface of the first operating member 230 and the other latch 252 is engaged with and held by the latching portion 278b on the upper surface of the second operating piece 232.

When the first binding ring 212 is closed, the opening/closing member 240 is twisted and urges the first and second operating pieces 230 and 232 to the directions to open the first binding ring 212.

One end of the compression spring 254 wound on the pivot shaft 238 of the operating member 218 is in contact with the inner surface of the pivot shaft bearing 270 of one of the operating pieces, or the first operating piece 230 of the operating member 218 and presses the first operating 230 outwards. The other end of the compression spring 254 is in contact with the inner surface of the pivot shaft bearing 272 of the other operating piece, or the second operating piece 232 of the operating member 218 and presses the second operating piece 232 outwards.

When the first binding ring 212 is closed, the compression spring 254 is, within the gap 244 for opening/closing member, in contact with the pivot shaft bearings 270 and 272 so as to move the first and second operating pieces 230 and 232 outwards longitudinally along the pivot shaft 238. A space is provided between the pivot shaft pieces 234a and 236a and between the pivot shaft pieces 234b and 236b.

When the first and second binding rings 212 and 214 are opened by twisting with fingers, the opening/closing member 240 is compressed, and when the fingers are relaxed or removed, the compression spring 254 of the opening/closing member 240 is released from the compression and expands slightly to urge the first and second operating pieces 230 and 232 to move them in the opposite directions.

The opening/closing member 240 according to this preferred embodiment is thus arranged, within the space of the holding member 216, so as to move the first and second operating pieces 230 and 232 in the opposite direction along the length of the holding member 216, and also to hold the first and second operating pieces 230 and 232 constituting the holding member 216 in the inverse V shape arrangement, namely in the state where the abutting edge 230a of the first operating piece 230 and the abutting edge 232a of the second operating piece 232 are brought closer to the inner surface of the bound article mounting portion 222 of the holding member 216.

When the first and second binding rings 212 and 214 start opening, the first and second operating pieces 230 and 232 constituting the operating member 218 exert action such that the binding ring halves 212a and 212b of the first binding ring 212 are separated from each other (i.e. the binding ring half 212a is moved to the direction O₁ and the binding ring half 212b to the direction O₂ (see FIG. 32)) and the binding ring halves 214a and 214b of the second binding ring 214 are separated from each other (i.e. the binding ring half 214a is moved to the direction O₁ and the binding ring half 214b to the direction O₂ (see FIG. 32)). When the respective binding ring latching portions 260 of the first and second binding rings 212 and 214 are then disengaged with fingers, the opening/closing member 240, which has been compressed, exerts action, in its attempt to restore to the original state, such that the first and second operating pieces 230 and 232 are moved in the opposite directions.

Further, the opening/closing member 240, which has been twisted, tends to restore to its original state and exerts action such that the binding ring halves 212a and 212b and the binding halves 214a and 214b are moved apart from each other in the circumferential directions (in the directions O₃ and O₄ (see FIG. 32)).

The first and second operating pieces 230 and 232 constituting the operating member 218 is thus transformed from the flat state to a state where they form an inverse V shape arrangement in cross section.

When the first and second binding rings 212 and 214 are opened, the opening/closing member 240 exerts action such that the first and second operating pieces 230 and 232 are held in the state where the abutting edge 230a of the first operating piece 230 and the abutting edge 232a of the second operating piece 232 are brought close to the inner surface of the bound article mounting portion 222 of the holding member 216, that is in the state where the first and second operating pieces 230 and 232 form an inverse V shape arrangement in cross section.

The first binding ring 212 preferably includes the pair of semi-circular binding ring halves 212a and 212b arranged to form a substantially annular shape. The second binding ring 214 also includes the pair of semi-circular binding ring halves 214a and 214b to form a substantially annular shape. The first and second binding rings 212 and 214 are provided with the latch portion 260 at the tip ends of the binding ring halves 212a and 212b and of the binding ring halves 214a and 214b, so that a sheet P can be bound by passing the binding rings through binding holes pre-formed in the sheet P and latching the respective latch portions 260.

The binding ring halves 212a and 212b constituting the first binding ring 212 are engaged together, forming an annular shape, by engaging the respective latch portions 260 of the binding ring halves 212a and 212b with each other.

The binding ring halves 214a and 214b constituting the second binding ring 214 are also engaged together, forming an annular shape, by engaging the respective latch portions 260 of the binding ring halves 214a and 214b with each other.

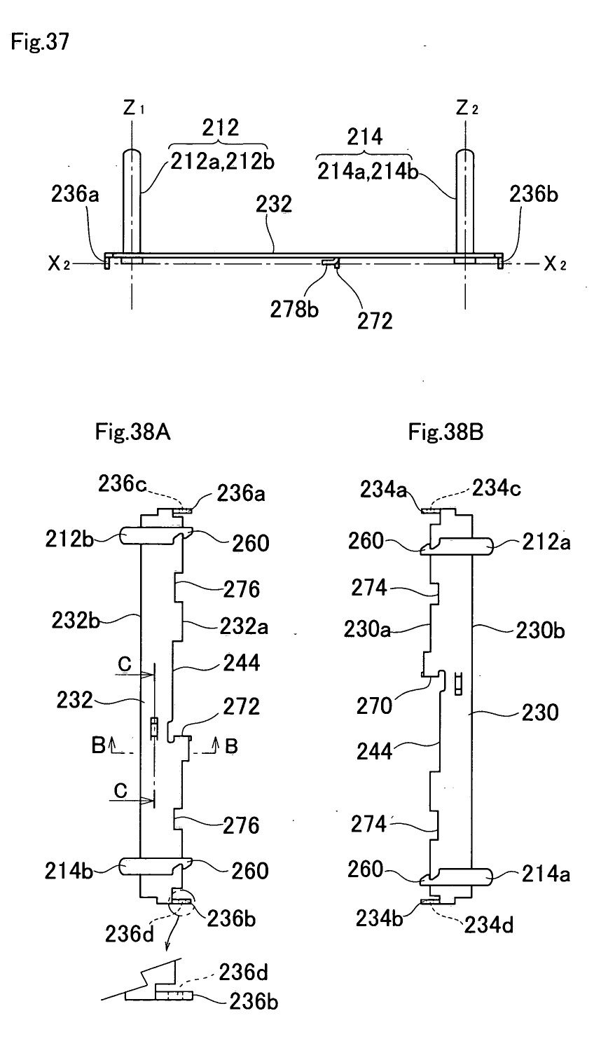

The first and second binding rings 212 and 214 are arranged to stand erect from the first and second operating pieces 230 and 232 so as to each define a plane that is substantially perpendicular to the plane P_{XY} including the axes Y₁ and Y₂ and the axes X₁ and X₂ passing respectively the two points (four points in total) where the bases of the first and second binding rings 212 and 214 are anchored to the first and second operating pieces 230 and 232 (see FIGS. 29 and 32). The circular plane defined by the axis Z₁ of the first binding ring 212 (see FIG. 37) and the circular plane defined by the axis Z₂ of the second binding ring 214 (see FIG. 37) are substantially parallel with each other and substantially perpendicular to the plan P_{XY} including the points where the first and second binding rings 212 and 214 are anchored to the first and second operating pieces 230 and 232.

The first and second binding rings 212 and 214 are thus arranged such that the respective binding ring latching portions 260 can be disengaged in the same direction using fingers.

The binding ring latching portion 260 disposed at the tip end of the binding ring half 212a constituting the first binding ring 212 includes a projection 262a and a recess 262b following this projection 262a at the tip end thereof, and the binding ring latching portion 260 disposed at the tip end of the binding ring half 212b includes a projection 264a and a recess 264b following this projection 264a at the tip end thereof. The projections 262a and 264a are arranged to project in mutually opposite directions, and the recesses 264b and 264b are recessed in mutually opposite directions, so that they engage with each other when the first binding ring 212 is closed. The projections 262a and 264a are each provided with a sloping edge extending inwards from the tip end, so that the first and second binding rings 212 and 214 can be opened/closed, sliding along these sloping edges.

In a similar manner, the binding ring latching portion 260 disposed at the tip end of the binding ring half 214a constituting the second binding ring 214 includes a projection 266a and a recess 266b following this projection 266a at the tip end thereof, and the binding ring latching portion 260 disposed at the tip end of the binding ring half 214b includes a projection 268a and a recess 268b following this projection 268a at the tip end thereof. The projections 266a and 268a are arranged to project in mutually opposite directions, and the recesses 266b and 268b are recessed in mutually opposite directions, so that they engage with each other when the first binding ring 214 is closed.

Further, the projection 262a constituting the binding ring latching portion 260 of the binding ring half 212a and the projection 266a constituting the binding ring latching portion 260 of the binding ring half 214a are arranged to project in the same direction.

Similarly, the recess 264b constituting the binding ring latching portion 260 of the binding ring half 212b and the recess 268b constituting the binding ring latching portion 260 of the binding ring half 214b are arranged to be recessed in the same direction.

Accordingly, the binding ring latching portion 260 of the first binding ring 212 can be disengaged by twisting the top of the first binding ring 212 with fingers. When the binding ring latching portion 260 of the first binding ring 212 is thus disengaged with fingers, the first and second operating pieces 230 and 232 are subjected to a force generated by the opening/closing member 240 to recover the original state, or to expand, and are urged to move to the opposite directions. The restoring force of the opening/closing member 240 that has been twisted acts in a direction so as to separate the projection 266a of the binding ring half 214a constituting the second binding ring 214 from the projection 268a of the binding half 214b, and also in a direction so as to separate the projection 262a of the binding ring half 212a constituting the first binding ring 212 from the projection 264a of the binding ring half 212b.

According to this preferred embodiment, therefore, it is possible to disengage the binding ring latching portions 260 of the binding ring halves 212a and 212b of the first binding ring 212 and the binding ring latching portions 260 of the binding ring halves 214a and 214b of the second binding ring 214 just by twisting the top parts of the first and second binding rings 212 and 214 with fingers.

The binder 210 can be attached to the cover A by using bolts and nuts through the attaching holes 220, with the bottom edges of the holding walls 224a and 224b joined to the cover.

The preferred embodiment as described above relates to a 2-hole type binder, having two binding rings such as the first and second binding rings 212 and 214. However, a binder according to various preferred embodiments of the present invention may be provided with more binding rings, for example with 3, 4, 20, 26 or 30 binding rings.

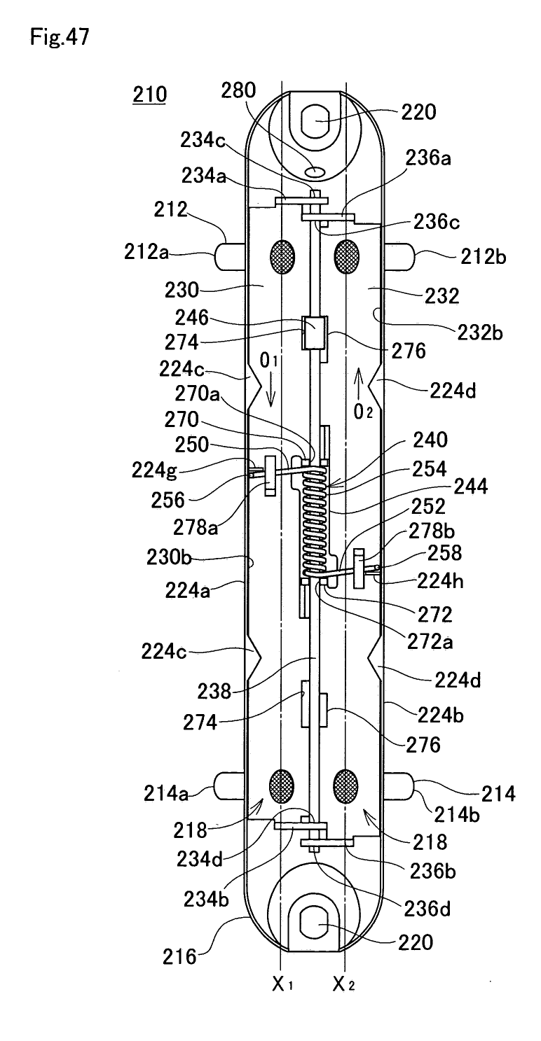

Next, a further modified preferred embodiment of the binder as illustrated in FIGS. 26 through 46 will be described principally with reference to FIGS. 47 through 57.

This modified preferred embodiment only differs from the preferred embodiment in FIGS. 26 through 46 in the holding member 216 and in that the opening/closing member 240 is fixed to the holding member 216, and other aspects of the constitution are similar thereto.

Therefore, only those parts and components that are different from those in FIGS. 26 through 46 will be described by adding drawings relevant thereto. For the other parts and components, FIGS. 26 through 46 will be referred to, using the same reference numerals.

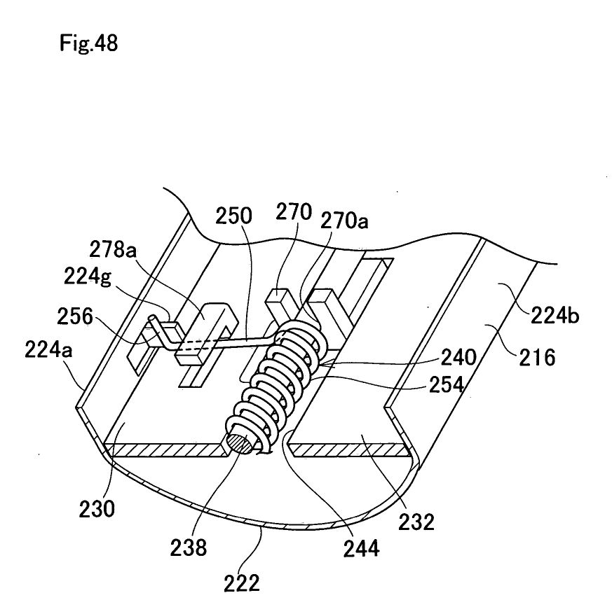

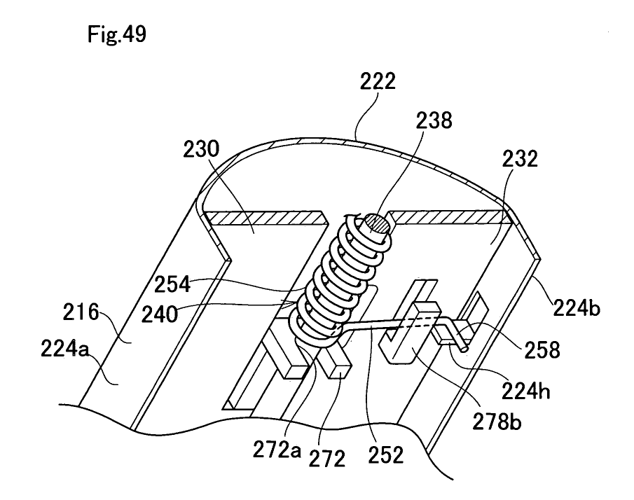

FIG. 47 is a bottom view of a binder in the closed state, FIG. 48 a perspective view illustrating the principal parts of the binder in the closed state, and FIG. 49 a perspective view illustrating the principal parts of the binder in the closed state.

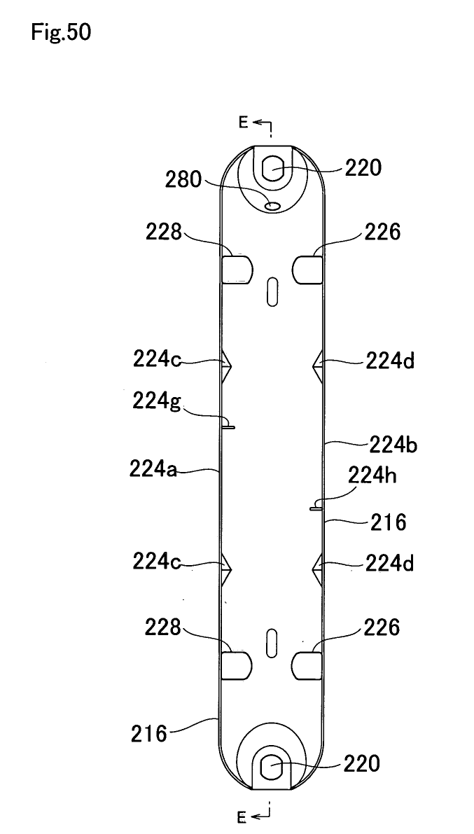

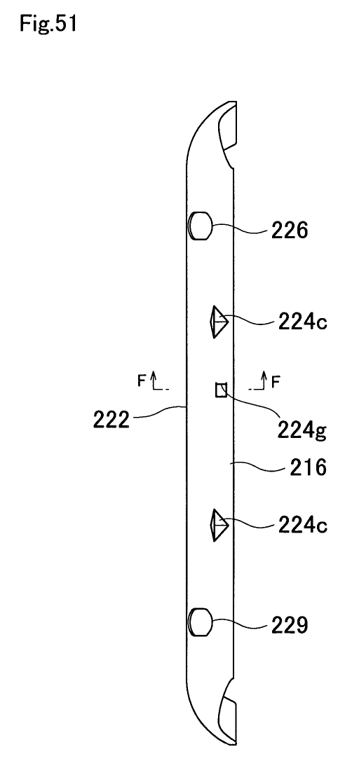

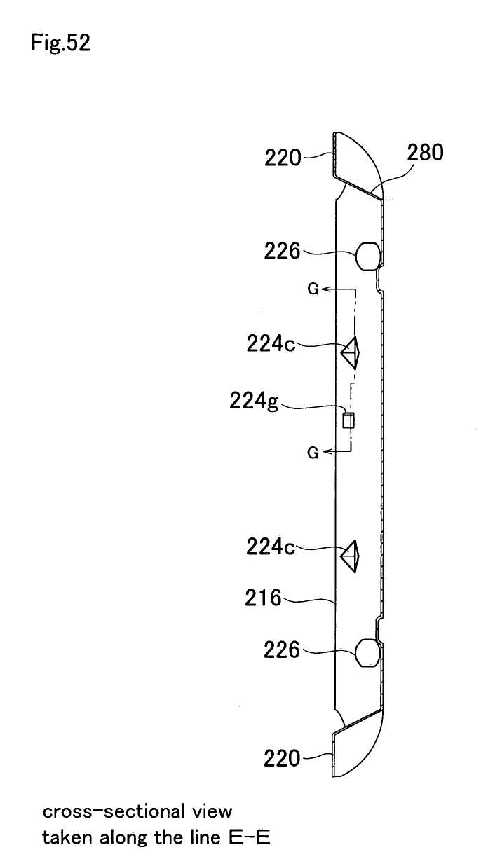

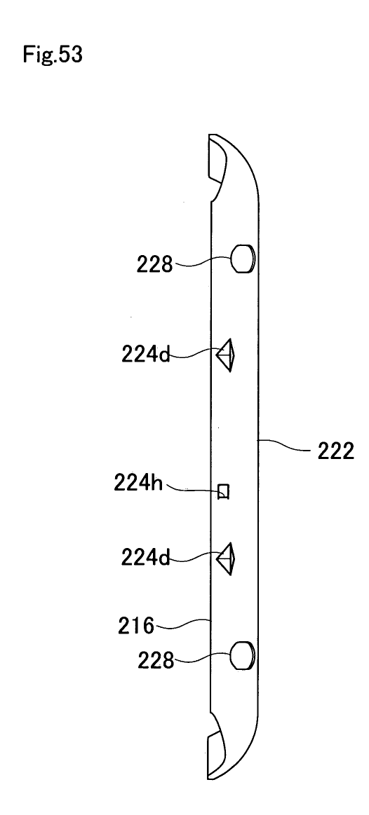

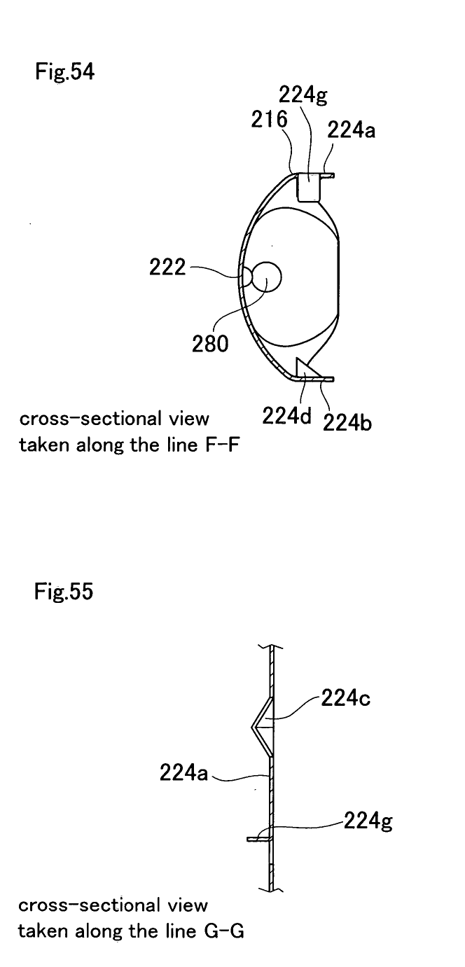

FIG. 50 is a bottom view of a holding member, FIG. 51 a left side view of the holding member, FIG. 52 a cross-sectional view taken along the line E-E in FIG. 50, FIG. 53 a right side view of the holding member, FIG. 54 a cross-sectional view along the line F-F in FIG. 51, and FIG. 55 a cross-sectional view along the line G-G in FIG. 52.

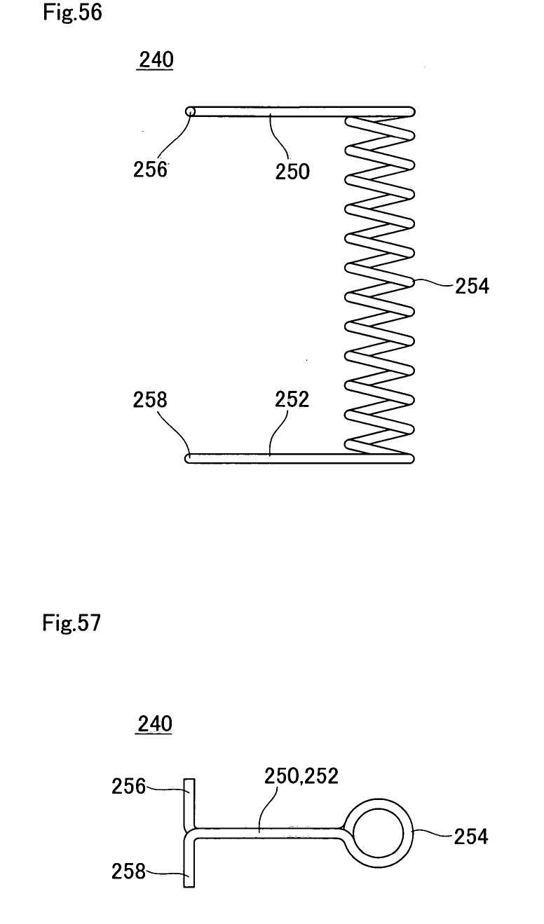

FIG. 56 is a front view showing an opening/closing member, and FIG. 57 is a side view of the opening/closing member.

This binder 210 includes a holding member 216, an operating member 218 and an opening/closing member 240.

The holding member 216 is provided, on respective holding walls 224a and 224b thereof in the vicinity of latches 250 and 252 of the opening/closing member 240, with a movement restricting portion 224g and a movement restricting portion 224h, respectively, by cutting out the holding walls 224a and 224b and folding the cut pieces inwards.

The movement restricting portions 224g and 224h are formed to have a substantially rectangular shape and to stand upright at an angle of approximately 90 degrees with respect to the holding walls 224a and 224b.

The opening/closing member 240 for activating the operating member 218 is wound around a pivot shaft 238 for pivotably holding first and second operating pieces 230 and 232. The latch 250 of the opening/closing member 240 is engaged with and held by a latching portion 278a of the first operating piece 230, while the latch 252 of the opening/closing member 240 is engaged with and held by a latching portion 278b of the second operating piece 232.

When the opening/closing member 240 is latched by the first and second operating pieces 230 and 232, the tip ends of the latches 250 and 252 of the opening/closing member 240 are folded towards the lower edge side of the holding walls 224a and 224b of the holding member 216 to form movement restricting portions 256 and 258, respectively.

The movement restricting portions 256 and 258 of the opening/closing member 240 are formed by folding the tip ends of the latches 250 and 252 in the vicinity of the movement restricting portions 224g and 224h of the holding member 216 at an angle of approximately 90 degrees such that these movement restricting portions 256 and 258 abut against the lower side surface (as seen in FIG. 47) of the movement restricting portion 224g of the hold member 216 and against the upper side surface (as seen in FIG. 47) of the movement restricting portion 224h of the holding member 216.

In this manner, the latch 250 of the opening/closing member 240 is engaged by and held by the latching portion 278a of the first operating piece 230 and, at the same time, the movement restricting portion 256 at the tip end of the latch 250 abuts against the movement restricting portion 224g of the holding member 216. The latch 252 of the opening/closing member 240 is engaged by and held by the latching portion 278b of the second operating piece 232 and, at the same time, the movement restricting portion 258 at the tip end of the latch 252 abuts against the movement restricting portion 224h of the holding member 216′. According to this constitution, when the first and second binding rings 212 and 214 are opened/closed, the first and second operating pieces 230 and 232 are caused to slide longitudinally along the pivot shaft 238. The first operating piece 230 will not hinder the sliding movement of the pivot shaft piece 234a towards the pivot shaft piece 236a (downwards as seen in FIG. 47), and the second operating piece 232 will not hinder the sliding movement of the pivot shaft piece 236a towards the pivot shaft piece 234a (upwards as seen in FIG. 47). The movement of the operating member 218 and pivot shaft 238 in the longitudinal direction of the holding member 216 is restricted by the movement restricting portions 224g and 224h. Further, the upward movement of the first operating piece 230 and the downward movement of the second operating piece 232 are also restricted. Therefore, even if the holding member 216, the first operating piece 230, the second operating piece 232, and the pivot shaft 238 are made of metal, these components hardly make noise when operated.

According to various preferred embodiments of the present invention, it is possible to provide a binder that can be opened/closed relatively easily only by handling manually the tops of binding rings.

The present invention is not limited to each of the above-described preferred embodiments, and various modifications are possible within the range described in the claims. An embodiment obtained by appropriately combining technical features disclosed in each of the different preferred embodiments is included in the technical scope of the present invention.

What is claimed is:

1. A binder comprising:
binding rings;
a holding member having a length that allows said binding rings to be arranged with a spacing therebetween; and
an operating member on a surface of which said binding rings are anchored at bases thereof with spacing therebetween, and which is movably fixed to an inner side of said holding member such that the binding rings are fixed to the holding member;
the operating member including a pair of operating pieces moving within the holding member in a longitudinal direction of the holding member, and a pivot shaft portion arranged along abutting edges of said pair of operating pieces;
one of the bases of each of the binding rings being fixed to one of said operating pieces and the other of the bases being fixed to the other operating piece;
the binder also including an opening/closing member that, for opening the binding rings, moves the operating pieces within the holding member in the longitudinal direction of the holding member, while rotating the pair of operating pieces around said pivot shaft portion in directions so as to open the binding rings.

2. The binder according to claim 1, wherein substantially cylindrical slide portions are provided along the abutting edge of one of said operating pieces at spaced intervals and cylindrical slide portions are disposed along the abutting edge of the other operating piece so as to be loosely fitted between said substantially cylindrical slide portions, a pivot shaft being arranged to pass through the substantially cylindrical slide portions.

3. The binder according to claim 1, wherein the opening/closing member is provided in a gap defined between the substantially cylindrical slide portions of the operating pieces.

4. The binder according to claim 1, wherein a gap is defined between the substantially cylindrical slide portions of the operating pieces so that the opening/closing member is provided in the gap; and
an inner end of the cylindrical slide portion of one of the operating pieces faces said gap, and, in opposition to the inner end, an inner end of the substantially cylindrical slide portion of the other operating piece faces said gap.

5. The binder according to claim 1, wherein a first pivot shaft piece is disposed at the abutting edge of one of the operating pieces, a second pivot shaft piece is disposed at the abutting edge of the other operating piece to be overlapped with the first pivot shaft piece, and a pivot shaft is passed between said first and second pivot shaft pieces.

6. The binder according to claim 1, wherein a gap is disposed at the abutting edges of the operating pieces so that the opening/closing member is provided in the gap, a gap-side inner end of one of the operating pieces faces the gap, and, in opposition to the gap-side inner end, a gap-side inner end of the other operating piece faces the gap.

7. The binder according to claim 1, wherein said opening/closing member includes an elastic member, and said elastic member is provided between a pair of operating pieces constituting said operating member for moving the pair of operating pieces in the opposite directions, respectively, and for elastically urging the pair of operating pieces in the directions to hold the binding rings in the opened or closed state.

8. The binder according to claim 1, wherein the elastic member includes a coil spring and the coil spring is wound around the pivot shaft of the operating member, and arranged in contact with the substantially cylindrical slide portion of one of the operating pieces of the operating member and with the substantially cylindrical slide portion of the other operating piece such that one end of the coil spring presses one of the operating pieces of the operating member, and the other end pressing the other operating piece.

9. The binder according to claim 1, wherein the elastic member includes a coil spring, and the coil spring is wound around the pivot shaft portion and is arranged in contact with a gap-side inner end of one of the operating pieces and with a gap-side inner end of the other operating piece such that one end of the coil spring presses one of the operating pieces of the operating member, and the other end pressing the other operating piece.

10. The binder according to claim 1, wherein the holding member is provided with a movement restricting portion on an inner surface of a holding wall inside of which the operating member is disposed, a latch of the opening/closing member extending towards the holding wall of the holding member is engaged with and held by a latching portion of the operating piece, while abutting against the movement restricting portion of the holding member, for restricting the movement in the holding member of the operating member disposed inside the holding member and of the opening/closing member for activating the operating member.

11. A method for manufacturing a binder including binding rings, a holding member having a length to allow said binding rings to be arranged with spacing therebetween, and an operating member on a surface of which said binding rings are anchored at bases thereof with a spacing therebetween, and which is movably fixed to an inner side of said holding member such that the binding rings are fixed to the holding member, said method comprising the steps of:
juxtaposing, inside the holding member, a pair of operating pieces constituting the operating member, one of the bases of each binding ring being fixed to one of said operating pieces and the other of the bases being fixed to the other operating piece, such that these operating pieces are capable of moving in a longitudinal direction of the holding member within the holding member;
inserting a pivot shaft through a pivot shaft portion formed at abutting edges of said pair of operating pieces from a pivot shaft insertion hole formed on a longitudinal central line of the holding member; and
fixing an opening/closing member to the pivot shaft portion, such that the opening/closing member moves the operating pieces within the holding member in the longitudinal direction of the holding member, while rotating the pair of operating pieces around said pivot shaft portion in directions to open the binding rings.

12. The method for manufacturing a binder according to claim 10, wherein said step of juxtaposing the operating pieces includes a step of juxtaposing a pair of operating pieces having a pivot shaft piece constituting the pivot shaft portion formed at the respective abutting edges such that the pivot shaft pieces of the pair of operating pieces are overlapped with each other; and
said step of inserting the pivot shaft includes a step of inserting the pivot shaft between said pivot shaft pieces.
